(19) United States
(12) Patent Application Publication
(10) Pub. No.: US 2025/0142493 A1
(43) Pub. Date: May 1, 2025

(54) POWER SAVING TIMERS ADJUSTMENT IN NON-TERRESTRIAL NETWORK AND CELLULAR DEVICES SYSTEM

(71) Applicant: SHARP KABUSHIKI KAISHA, Sakai city, Osaka (JP)

(72) Inventor: EDWARD MASAMI SUGIYAMA, Vancouver, WA (US)

(21) Appl. No.: 18/693,778

(22) PCT Filed: Sep. 22, 2022
(86) PCT No.: PCT/JP2022/035511

§ 371 Date: Mar. 20, 2024

Related U.S. Application Data
(60) Provisional application No. 63/261,647, filed on Sep. 24, 2021.

(51) Int. Cl. H04W 52/42; H04W 52/02; H04W 76/28

(52) U.S. Cl. CPC H04W 52/42; H04W 52/0219; H04W 76/28

(57) ABSTRACT

Various apparatus and methods are disclosed for controlling operation of a wireless terminal in a non-terrestrial network (NTN). Nodes for controlling such wireless terminals are disclosed, as well the wireless terminals. Corresponding methods are disclosed for the various embodiments of nodes and wireless terminals.

### CROSS REFERENCE

This Nonprovisional application claims priority under 35 U.S.C. § 119 on provisional Application No. 63/261,647 on Sep. 24, 2021, the entire contents of which are hereby incorporated by reference.

### TECHNICAL FIELD

The technology relates to wireless communications, and particularly to operation and adjustment of timers in a wireless terminal for power saving purposes.

### BACKGROUND ART

A wireless terminal, also known as a wireless cellular device, mobile station, mobile terminal, user equipment, or more simply “UE”, typically communicates across an air or radio interface either with a radio access network or, in some instances, another wireless terminal. The radio access network generally comprises one or more access nodes, such as a base station node. In some more recent technologies, the base station has also been referred to as an eNodeB, eNB, or gNB. Nodes of the radio access network are typically in turn connected to nodes of a core network.

A wireless terminal may operate in several states or modes, including a connected mode, an idle mode, and a power saving mode, PSM. In the connected mode the wireless terminal may be participating in an active connection. In the idle mode the wireless terminal is not participating in an active connection but may be monitoring for a possible paging message or the like. In the power saving mode (PSM) the wireless terminal is essentially in “deep sleep” and is thus not expecting any significant interaction with the radio access network.

The aforementioned states or modes may be understood by way of example to a Radio Resource Control (RRC) state machine. As described herein, both an access node and a wireless terminal may manage a respective Radio Resource Control (RRC) state machine. The RRC state machines transition between several RRC states including RRC_IDLE, RRC_INACTIVE and RRC_CONNECTED. FIG. 1 depicts the state transition diagram of the RRC states. From the vantage point of a wireless terminal e.g., user equipment (UE), the RRC states may be briefly characterized as follows:

### RRC_IDLE:

A UE specific DRX (discontinuous reception) may be configured by upper layers;
UE controlled mobility based on network configuration;
The UE:
   Monitors a Paging channel;
   Performs neighboring cell measurements and cell (re-) selection;
   Acquires system information.

### RRC_INACTIVE:

A UE specific DRX may be configured by upper layers or by RRC layer;
UE controlled mobility based on network configuration;
The UE stores the Access Stratum (AS) context;
The UE:
   Monitors a Paging channel;
   Performs neighboring cell measurements and cell (re-) selection;
   Performs RAN-based notification area updates when moving outside the RAN-based notification area;
   Acquires system information.

### RRC_CONNECTED:

The UE stores the AS context.
Transfer of unicast data to/from UE.
At lower layers, the UE may be configured with a UE specific DRX;
Network controlled mobility, i.e. handover within NR and to/from E-UTRAN;
The UE:
   Monitors a Paging channel;
   Monitors control channels associated with the shared data channel to determine if data is scheduled for it;
   Provides channel quality and feedback information;
   Performs neighboring cell measurements and measurement reporting;
   Acquires system information.
      As used herein, a “layer” in the sense of “higher layer” and “lower layer” refers to one or more layers of the OSI model. As understood by those skilled in the art, the OSI model layers include (from lowest to highest) (1) the physical layer, (2) the data link layer, (3) the network layer, (4) the transport layer, (5) the session layer, (6) the presentation layer, and (7) the application layer. As used herein, “lower layer” refers to one or both of (1) the physical layer and (2) data link layer, so that any other layer is considered herein to be a higher layer.

As shown in FIG. 2, the durations of these various modes may be established, set, or maintained by various types of timers maintained by the wireless terminal, including, by way of example, a T3324 timer and a T3412 timer. The T3324 timer, also known as the “active timer”, may be used to establish the duration of the idle mode; the T3324 timer or “extended TAU timer T3324 timer” may be used to establish when the wireless terminal is to enter a tracking area update mode or return to connected mode after a previous connection release.

Some wireless cellular devices, including Cellular Internet of Things, CIoT, may communicate using Non-Terrestrial Network, NTN, satellites, and thus could consume additional power and thereby may reduce battery life expectancy. CIoT include Narrow Band IoT, NB-IoT, and Machine Type Communication devices, e.g., LTE-MTC and eMTC devices, which are usually low battery powered devices. For such devices issues leading to battery power consumption occur in following conditions using NTN:
NTN coverage is not available and the CIoT wakes up from deep sleep and attempts NPSS synchronization that fails, with the result that the radio communications circuitry of the device is powered on despite there being no cellular signal available or usable.
The Active Timer, T3324, which may operate with optional extended DRX, e.g., eDRX, cycles, is still running while NTN Coverage Period transitions to no coverage. Both power saving timers, e.g., the Extended TAU timer, T3412, and the Active Timer, T3324, start at end of connected mode. The duration of connected mode can vary and as a result, the expiration of these timers may occur in a NTN Gap Period, e.g., a period in which a wireless terminal has no coverage of the non-terrestrial network. In such case the CIoT radio circuitry consumes power as it attempts to reestablish communication with non-existent NTN.
The power saving timers T3324, T3412, and eDRX are only set during tracking area update or RRC attach. Currently, no methods exist to modify timers while in connected mode.
   Currently power saving is achieved by using timers that are requested by CIoT User Equipment (UE) but determined and set by the network. As shown in FIG. 2, the expiration of the timers enables the wireless terminal to change UE states from idle to deep sleep/Power Saving Mode (PSM). Power consumption is the highest when the wireless terminal or UE is in connected mode, followed by idle mode and the power saving mode (PSM). The power saving mode (PSM) utilizes the least amount of power. Idle Mode, as timed by timer T3324, may also utilize an optional extended-discontinuous reception, eDRX, timer/cycle, which is abbreviated as eDRx. During the e-DRX cycle, paging is monitored for a short period during a Paging Transmission Window, then the wireless terminal stops monitoring for paging messages for an extended duration. Once the wireless terminal reaches idle mode, as indicated by RRC Release, the TAU Extended timer, T3412, and the Active timer, T3324, start. If wireless terminal does not engage in data transactions, either downlink or uplink, during the T3324 period, the PSM starts after expiry of the T3324 timer. PSM duration lasts until expiration of the T3412 timer, i.e., the duration of PSM=T3412-T3324.

A non-terrestrial network, NTN, system utilizes Unmanned Aircraft System satellites that provides access to CIoT User Equipment (UE). Due to movement of satellites, the non-terrestrial network (NTN) may not be available for communication due to discontinuous or non-continuous coverage. As a result, the non-terrestrial network is reachable to/by the CIoT devices at specific date/time and the duration of non-terrestrial network access depends on the satellite, as illustrated in FIG. 3. An LTE Mobility Management Entity, MME, or in New Radio, NR, an Access and Mobility Management Function, AMF, manages location and network coverage information. MME and AMF are among the components/nodes in core network. Location and coverage information may be stored in the core network or an application server that is connected to the core network using a Service Capability Exposure Function, SCEF. Non-IP Data Delivery, NIDD, may be used for transport of location and coverage data between MME/AMF and possibly the SCEF.

In a terrestrial network, coverage is usually available after expiration of various timers. However, as explained above with reference to FIG. 3, in a non-terrestrial network (NTN) discontinuous coverage prevents connection to the network at various times of the day. For example, the wireless terminal may wake up after expiration of the T3412 timer even though network coverage is not available. As a result, wireless terminal consumes unnecessary power due to turning on the radio and searching for a network that does not exist.

The timer values chosen by wireless terminal and ultimately decided by the network may not be suitable for non-terrestrial network (NTN). To save battery power, wireless terminal should be in power saving mode (PSM) when non-terrestrial network (NTN) coverage is not available. Additionally, the Active Timer T3324 should not exceed or extend into the gap duration because radio is still powered on while in no coverage state.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 4, and is also described in 3GPP TS 38.300. The 5G NR network is comprised of NG RAN, Next Generation Radio Access Network, and 5GC (5G Core Network). As shown, NGRAN is comprised of gNBs, e.g., 5G Base stations, and ng-eNBs, i.e. LTE base stations. An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations, i.e., gNB & ng-eNB. A gNB node provides NR user plane and control plane protocol terminations towards the UE and is connected via the NG interface to the 5GC. The 5G NR (New Radio) gNB is connected to an Access and Mobility Management Function, AMF, and a User Plane Function, UPF, in a 5G Core Network, 5GC.

The 3rd Generation Partner Project (3GPP) is working on addressing power saving issues. NTN networks are not implemented so companies continue to submit proposals. Some proposals that have been submitted to the 3GPP suggest that changes may be needed to resolve various issues on non-terrestrial network (NTN) discontinuous coverage. Example 3GPP submissions which may be relevant to the subject matter of non-terrestrial network (NTN) coverage including the following, all of which are incorporated herein by reference in their entirety:
R2-2106486-[Pre114-e][006] [IoT NTN] Summary of 9.2.3 Other Open Issues (Ericsson)
R2-2108500, Discussion on support of Non continuous coverage, CMCC
R2-2108325, Support of Non continuous coverage, NEC.
R2-2108336, On Discontinuous coverage in IoT-NTN, MediaTek.
R2-2108171, Discussion on discontinuous coverage, Xiaomi.

What is needed, therefore, are methods, apparatus, and/or techniques for managing, controlling, or limiting the power required or expended by a wireless terminal in view of the wireless terminal being in or out of non-terrestrial network (NTN) coverage.

### SUMMARY OF INVENTION

In one example, a wireless terminal which communicates over a radio interface with a radio access network, the wireless terminal comprising: a power saving timer configured to establish duration of one or more operational modes of the wireless terminal, each operational mode being associated with a respective power utilization level by the wireless terminal; receiver circuitry configured to receive, via the radio access network and from a core network node, a timer value for the power saving timer, the timer value being based on non-terrestrial network (NTN) coverage information for the wireless terminal.

In one example, a core network node of a core network of a telecommunications system, the core network node comprising: processor circuitry configured to adjust a timer value for a power saving timer of a wireless terminal served by the core network, the timer value being based on non-terrestrial network (NTN) coverage information for the wireless terminal; and interface circuitry configured to transmit a message including the timer value to a radio access network which serves the wireless terminal.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing transition states of a Radio Resource Control RRC state machine.

FIG. 2 is a diagrammatic view showing relationships between operational modes having durations maintained by various timers of a wireless terminal and power consumption of the wireless terminal during the modes.

FIG. 3 is a diagrammatic view showing, as a function of time, coverage of a non-terrestrial network with reference to various satellites for a particular wireless terminal, including non-terrestrial network gap periods in which the wireless terminal has no non-terrestrial network coverage.

FIG. 4 is a diagrammatic view showing in generality an overall architecture for a fifth generation 3GGG communications system, including various nodes and interfaces.

FIG. 5 is a diagrammatic view showing a high-level generic view of a typical radio communication system which comprises a core network, one or more radio access networks, and a wireless terminal which includes one or more power saving timers.

FIG. 6 is a diagrammatic view depict preferred timer settings for NTN discontinuous coverage.

FIG. 7 is a diagrammatic view which illustrates a T3324 timer which may include multiple extended discontinuous reception, eDRX, cycles.

FIG. 8 is a diagrammatic view which illustrates communications and signals of various nodes and/or functionalities of a communications system, including a wireless terminal, an access node, an MME of a core node, an SCEF gateway, and an application server.

FIG. 9 is a schematic view showing various example, representative, non-limiting components and functionalities of a generic communications system in which non-terrestrial network (NTN) coverage information is utilized to set or adjust power saving timers of a wireless terminal.

FIG. 10 is a schematic view showing various example, representative, non-limiting components and functionalities of a communications system in which a wireless terminal sends one or more adjusted power saving timers to a core network.

FIG. 11 is a flowchart showing basic acts or steps performed by the wireless terminal of the example embodiment and mode of FIG. 10.

FIG. 12 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 13 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 14 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 15 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 16 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 17 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 18 illustrated scenario in which the act of FIG. 11 may be necessary in the example embodiment and mode of FIG. 10, with FIG. 12, FIG. 13 and FIG. 16 particularly showing problem situations, and corresponding FIG. 14, FIG. 15, and FIG. 17 showing example resolutions.

FIG. 19 is a schematic view showing various example, representative, non-limiting components and functionalities of a communications system in which a core network, and particularly a location and network coverage manager, generates and/or sends one or more adjusted power saving timer values to a wireless terminal.

FIG. 20 is a schematic view showing various example, representative, non-limiting components and functionalities of a communications system in which a core network, and particularly an application server, generates and/or sends one or more adjusted power saving timer values to a wireless terminal.

FIG. 21 is a schematic view showing various example, representative, non-limiting components and functionalities of a communications system in which a wireless terminal sends a request for an adjusted timer value, and the core network responds accordingly.

FIG. 22 is a schematic view showing various example, representative, non-limiting components and functionalities of a communications system in which a core network may include new or adjusted timer values in a connection release message.

FIG. 23 is a schematic view showing various example, representative, non-limiting components and functionalities of a communications system in which a core network may provide multiple candidate values for an adjusted timer value.

FIG. 24A is a diagrammatic view illustrating two example cases or corrective scenarios for which this example embodiment and mode of FIG. 23.

FIG. 24B is a diagrammatic view illustrating two example cases or corrective scenarios for which this example embodiment and mode of FIG. 23.

FIG. 25 is a schematic view showing various example, representative, non-limiting components and functionalities of a communications system in which a core network may provide a wireless terminal with a novel or new power savings timer for use in conjunction with a non-terrestrial network (NTN).

FIG. 26 is a diagrammatic view showing use of two new or novel timers provided by the example embodiment and mode of FIG. 25.

FIG. 27 is a flowchart showing representative, example acts or steps performed by a wireless terminal of the example embodiment and mode of FIG. 25.

FIG. 28 is a schematic view showing various example, representative, non-limiting components and functionalities of a communications system in which a core network may release a connection if the network determines that a non-terrestrial network (NTN) Gap Period is about to start.

FIG. 29 is a schematic view showing various example, representative, non-limiting components and functionalities of a communications system in which a message including an Release Assistance Indication may be used to change the state of wireless terminal to an idle mode and to request updated power saving timer(s).

FIG. 30 is a signaling diagram showing events and communications involved in performance of the example embodiment and mode of FIG. 29.

FIG. 31 is a diagrammatic view showing example elements comprising electronic machinery which may comprise a wireless terminal according to an example embodiment and mode.

### DESCRIPTION OF EMBODIMENTS

In various example embodiments and modes, the technology disclosed herein concerns various apparatus and methods for controlling operation of a wireless terminal in a non-terrestrial network (NTN). Nodes for controlling such wireless terminals are disclosed, as well the wireless terminals. In addition, corresponding methods are disclosed for the various embodiments of nodes and wireless terminals.

In one of its various aspects the technology disclosed herein concerns a wireless terminal which communicates over a radio interface with a radio access network. In a basic example embodiment and mode the wireless terminal comprises a power saving timer, processor circuitry, and transmitter circuitry. The power saving timer is configured to establish duration of one or more operational modes of the wireless terminal, each of the operational modes being associated with a power utilization level by the wireless terminal. The processor circuitry is configured to determine an adjusted timer value for the power saving timer, the adjusted timer value being based on non-terrestrial network (NTN) coverage information for the wireless terminal. The transmitter circuitry is configured to transmit the adjusted timer value for the power saving timer via the radio access network to a core network node. Methods of operation of such wireless terminal are also disclosed.

In another of its various aspects the technology disclosed herein concerns a node of a core network of telecommunications system. In a basic example embodiment and mode the core network node comprises processor circuitry and interface circuitry. The processor circuitry is configured to adjust a timer value for a power saving timer of a wireless terminal served by the core network, the timer value being based on non-terrestrial network (NTN) coverage information for the wireless terminal. The interface circuitry is configured to transmit a message including the timer value to a radio access network which serves the wireless terminal. Methods of operation of such node are also disclosed.

In one of its various aspects the technology disclosed herein concerns a wireless terminal which communicates over a radio interface with a radio access network. In a basic example embodiment and mode the wireless terminal comprises a power saving timer and receiver circuitry. The power saving timer is configured to establish duration of one or more operational modes of the wireless terminal, each of the operational modes being associated with a power utilization level by the wireless terminal. The receiver circuitry is configured to receive, via the radio access network and from a core network node, a timer value for the power saving timer, the timer value being based on non-terrestrial network (NTN) coverage information for the wireless terminal. Methods of operation of such wireless terminal are also disclosed.

In another of its various aspects the technology disclosed herein concerns a wireless terminal which communicates over a radio interface with a radio access network. In a basic example embodiment and mode the wireless terminal comprises a power saving timer; receiver circuitry, and processor circuitry. The power saving timer is configured to establish duration of one or more operational modes of the wireless terminal, each operational mode being associated with a respective power utilization level by the wireless terminal. The receiver circuitry is configured to receive, via the radio access network and from a core network node, plural candidate values for the power saving timer. The processor circuitry is configured to select, from among the plural candidate values, an appropriate timer value for use as a selected timer value for the power saving timer. Methods of operation of such wireless terminal are also disclosed.

In another of its various aspects the technology disclosed herein concerns a node of a core network which, in a basic example embodiment and mode, comprises processor circuitry and interface circuitry. The processor circuitry is configured to generate a new mode-duration determination parameter for a wireless terminal served by the node. The interface circuitry is configured to transmit a message including the new mode-duration determination parameter to a radio access network which serves the wireless terminal. In one example implementation the new mode-duration determination parameter is a parameter which express a time remaining until non-terrestrial network (NTN) coverage disappears for a wireless terminal served by the node. In another example implementation the new mode-duration determination parameter is a parameter which expresses duration of a non-terrestrial network (NTN) gap period for a wireless terminal served by the node. Methods of operating such nodes are also disclosed.

In another of its various aspects the technology disclosed herein concerns a wireless terminal which, in a basic example embodiment and mode, comprises receiver circuitry and processor circuitry. The receiver circuitry is configured to receive a new mode-duration determination parameter via the radio access network and from a core network node. The processor circuitry is configured to use the new mode-duration determination parameter to determine duration of a mode of operation of the wireless terminal. In one example implementation the new mode-duration determination parameter is a parameter which express a time remaining until non-terrestrial network (NTN) coverage disappears for a wireless terminal served by the node. In another example implementation the new mode-duration determination parameter is a parameter which expresses duration of a non-terrestrial network (NTN) gap period for a wireless terminal served by the node. Methods of operating such wireless terminals are also disclosed.

In another of its various aspects the technology disclosed herein concerns a core network of a telecommunications system. In a basic example embodiment and mode the node comprises processor circuitry and interface circuitry. The processor circuitry is configured, when a determination has been made that a non-terrestrial network (NTN) gap period is about to start for a wireless terminal served by the core network node, to (1) generate a connection release message for the wireless terminal; and (2) provide a timer value for a power saving timer of a wireless terminal served by the core network, the timer value being based on non-terrestrial network (NTN) coverage information for the wireless terminal. The interface circuitry is configured to transmit the connection release message and the timer value to a radio access network which serves the wireless terminal. Methods of operating such nodes are also disclosed.

In another of its various aspects the technology disclosed herein concerns a wireless terminal which communicates over a radio interface with a radio access network. In a basic example embodiment and mode the wireless terminal comprises receiver circuitry and processor circuitry. The receiver circuitry is configured to receive, via the radio access network from a core network node that serves the wireless terminal, a connection release message, the connection release message having been sent to the wireless terminal from the core network node when the core network node has made a determination that a non-terrestrial network (NTN) gap period is about to start for the wireless terminal. The processor circuitry is configured, upon receipt of the connection release message, to transition the wireless terminal into a power saving mode. Methods of operating such wireless terminals are also disclosed.

In another of its various aspects the technology disclosed herein concerns a core network of a telecommunications system. In a basic example embodiment and mode core network node comprises interface circuitry and processor circuitry. The interface circuitry is configured to receive, via a radio access network from a wireless terminal: (1) an early release indication which has been generated when a determination has been made that the wireless terminal has no additional data to transmit across the radio interface and that the wireless terminal should change state from a connected mode to an idle mode; and (2) a request for an updated value for a power saving timer of the wireless terminal. The processor circuitry is configured to configure the updated value for the power saving timer of the wireless terminal. The interface circuitry is further configured to transmit, via the radio access network, a connection release message and the updated value for the power saving timer. Methods of operating such nodes are also disclosed.

In another of its various aspects the technology disclosed herein concerns a wireless terminal which communicates over a radio interface with a radio access network. In a basic example embodiment and mode the wireless terminal comprises processor circuitry, transmitter circuitry, and receiver circuitry. The processor circuitry is configured to make a determination that the wireless terminal has no additional data to transmit across the radio interface and that the wireless terminal should change state from a connected mode to an idle mode. Further, in accordance with the determination, the processor circuitry is configured to generate an early release indication and to generate a request for an updated value for a power saving timer of the wireless terminal. The transmitter circuitry is configured to transmit the early release indication and the request for the updated value for the power saving timer to a core network node via the radio access network. The receiver circuitry is configured to receive, via the radio access network, a connection release message and the updated value for the power saving timer. Methods of operating such wireless terminals are also disclosed.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network including a non-terrestrial network (NTN). Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, CIoT devices, MTC and eMTC devices, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, 13, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

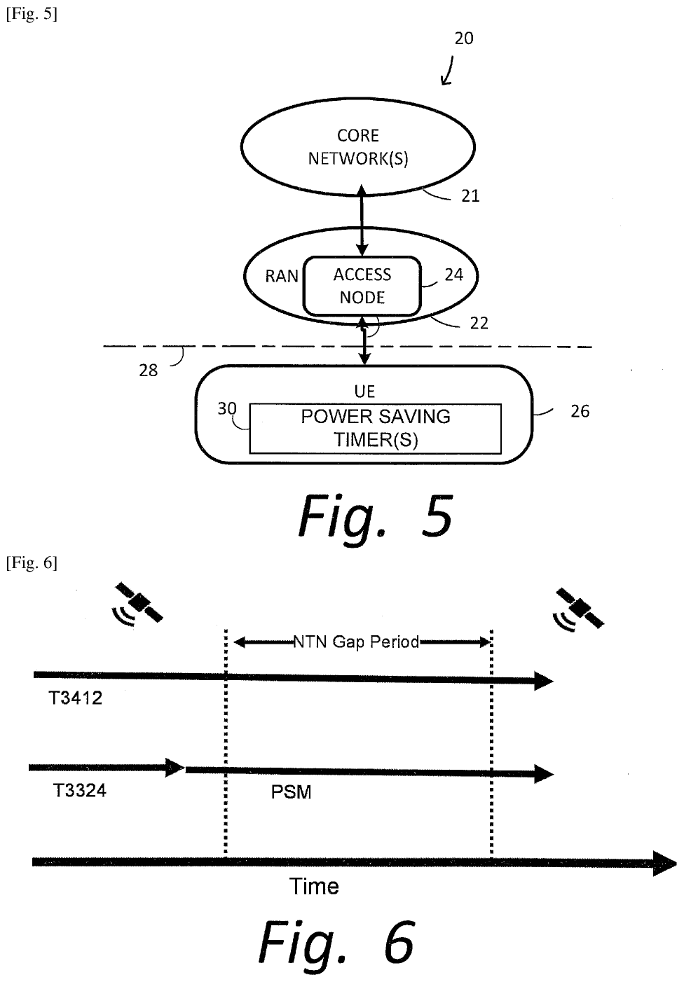

As illustrated by the high-level generic view of FIG. 5, a typical radio communication system 20 comprises a core network 21; one or more radio access networks (RAN) 22 including one or more base stations or access nodes 24, and terminal devices used by the end users, represented by wireless terminal or UE 26. The access node 24 and the wireless terminal 26 communicate over an air or radio interface 28, which is also known as the Uu interface for LTE. The wireless terminal 26 comprises one or more power saving timers 30, such as the T3412 timer and the T3324 timer as discussed herein.

The Core Network (CN) 21 includes the central part of the radio communication system that provides various services to customers who are connected by the radio access network 22. The core network for the Global System for Mobile Communication (GSM) is called the GSM Network Switching Subsystem or NSS or the GSM core network; the core network for the Universal Mobile Telecommunications System (UMTS) is a migration of that used for GSM with further elements overlaid to enable the additional functionality demanded by UMTS and is called the UTMS core network; the core network in the 4G network is called Evolved Packet Core (EPC), and the core network in the 5G network is referred as 5G Core Network (5GC).

The Radio Access Network (RAN) 22 comprises, e.g., is a part of a radio communication system that resides between terminal devices such as wireless terminal 26 and a core network 21. The RAN 22 provides connectivity to the devices through radio interfaces via the base station(s) or access node(s) 24, e.g., via eNB (in LTE/LTE-A RAN) or via gNB (in 5G RAN). The terminal devices 26 which are used by end users are also referred to as wireless terminals or User Equipment (UE). As used herein, the wireless terminal 26 may be an enhanced Machine-Type Communication (eMTC) device or a Narrow Band Internet of Things (NB-IoT) device.

Example embodiment and modes of the technology disclosed herein concern managing, controlling, or limiting the power required or expended by a wireless terminal in view of coverage, or being out of coverage, of a non-terrestrial network (NTN). As particular examples, the technology disclosed herein proposes methods to conserve power and extend battery life of CIoT User Equipment devices that are utilizing a non-terrestrial network (NTN) and addresses issues of NTN discontinuous coverage. Example methods described herein and encompassed hereby may include:
a wireless terminal may adjust a power saving timer during and/or at the end of data connected mode. This allows multiple entryways to fine tune power saving timers.
a core network, which may include nodes or equipment ush as 4G LTE (MME) and/or 5G NR (AMF), may adjust power saving timer values accordingly based on NTN coverage information. One or both of the wireless terminal and the core network may determine and negotiate ideal power saving timer values based on accessibility of NTN.
the introduction of additional timers and counters specifically for NTN power saving, e.g., timers in addition to the T3412 timer and T3324 timer. The new timers, e.g., values for the new timers, may be calculated by the wireless terminal and/or network. Whereas the T3412 timer and the T3324 timer may be referred to herein as “pre-existing timers”, the new timers may be described as “not pre-existing timers” and/or “new mode-duration determination parameters”. As examples, expiry of these new timers may correspond to NTN coverage and Gap Periods.
The network, e.g., the core network, may release an RRC Connection so that device immediately transitions to PSM.

In some of its example aspects the technology disclosed herein includes adjusting various power saving parameters so that the wireless terminal may be in a deep sleep state during the NTN Gap Period. The wireless terminal consumes the least amount of battery power while in PSM. Maximum power saving using NTN are achieved if following are true:
the NTN Gap Period falls within duration of PSM (T3412-T3324).
The PSM start and/or end times are not within NTN Gap Period.
The T3324 Active Timer, that may include optional eDRX timers, expires before start of NTN Gap Period.
   FIG. 6 depicts ideal timer settings for NTN discontinuous coverage. In the example of FIG. 6, the wireless terminal is in PSM or deep sleep mode, e.g., least power consumption, during an NTN Gap Period. If NTN coverage is available, the wireless terminal is in Connected or Idle mode allowing data transactions and monitoring of paging messages.

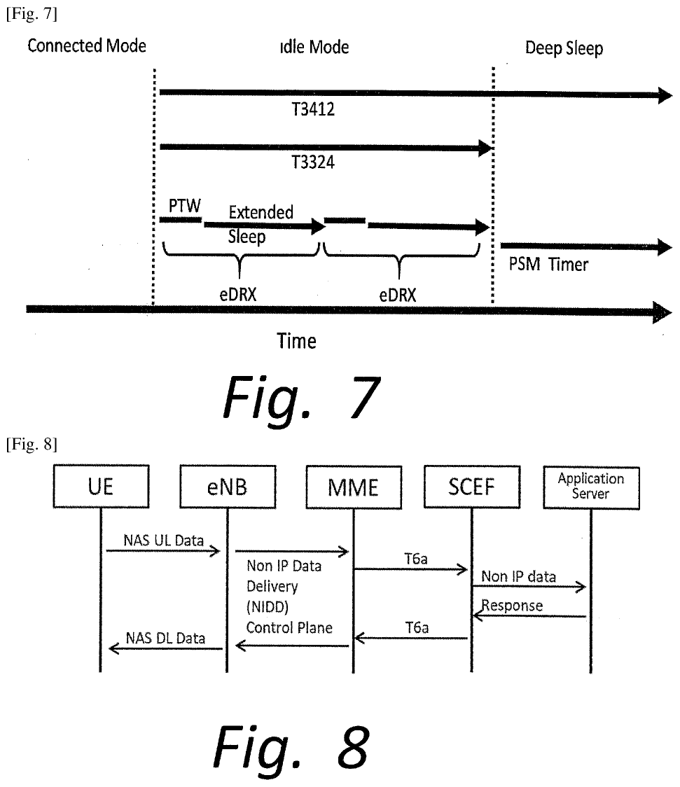

It should be understood that the T3324 Active Timer of FIG. 6 may also optionally include extended discontinuous reception cycles, e.g., eDRX. An eDRX may comprise a Paging Time Window (PTW) and an extended sleep period. While in PTW, radio circuitry of the wireless terminal monitors for paging occasions, PO. During an extended sleep period, the radio circuitry of the wireless terminal does not monitor for PO, in order, e.g., to reduce power consumption. The T3324 timer may include multiple eDRX cycles, as shown in FIG. 7.

As described in various example embodiments and modes herein, the calculation and management of power saving timers, such as T3412 timer and T3324 timer, for example, may be performed in/by the wireless terminal or in/by the network, e.g., the core network. The network may include functionalities such as MME/AMF, discussed above, and/or external application server(s). In some example embodiments and modes Uplink (UL) data encapsulated in a non-access stratum, NAS, message may originate from the wireless terminal. Such UL data may contain information relevant to power savings including modified timers and requests. Downlink (DL) data may contain a response from MME/AMF and/or the application server(s). If an application server is utilized, data may be exchanged using SCEF gateway between MME/AMF and the application server, as illustrated in FIG. 8

Current 3GPP specifications state that the T3324 timer, T3412 timer, and the eDRX timer, e.g., the values for such timers, are requested by wireless terminal and set by the network using TAU/Attach request and accept messages. Due to the variability of RRC data connection duration, the start of such timers may occur near the end of NTN Coverage Period. As a result, one of the timers may expire during NTN Gap Period which, as explained above, is undesirable as wasting power of the wireless terminal. Although 3GPP has received some proposals which purport to address power saving for wireless terminal with timers expiring NTN discontinuous coverage, most of such 3GPP proposals focus on the network sending location assistance data from which the wireless terminal calculates NTN coverage and Gap Periods. However, because a CIoT wireless terminal utilizes battery and generally has a lower performance CPU, executing intensive calculations required by such proposals may not be feasible nor desirable. Accordingly, in some of its example aspects the technology disclosed herein allows one or both of the network and the wireless terminal to determine and adjust one or more of the power saving timers and thereby maximize battery usage of the CIoT wireless terminal.

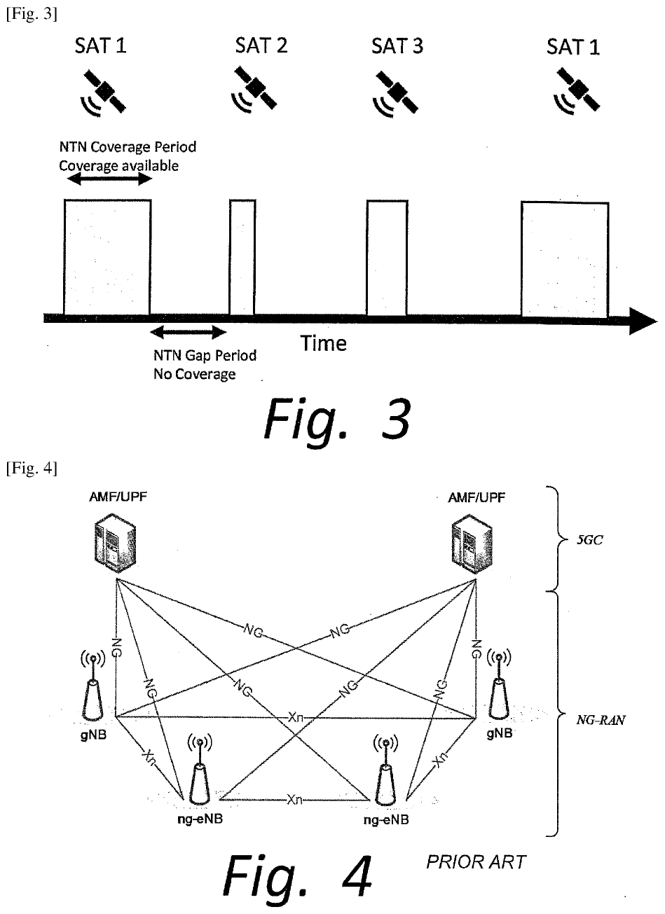

FIG. 3 shows various example, representative, non-limiting components and functionalities herein pertinent of a generic wireless terminal 26 which comprises a power saving timer 30, as well as selected other generic aspects of communication system 20. As used herein, “power saving timer 30” should be understood to include one or more of a T3412 timer, a T3324 timer, and an eDRX timer, which are also described herein as “pre-existing” or “conventional” power saving timers, as well as further new or “non-pre-existing” timers and/or new mode-duration determination parameters which are proposed by the technology disclosed herein.

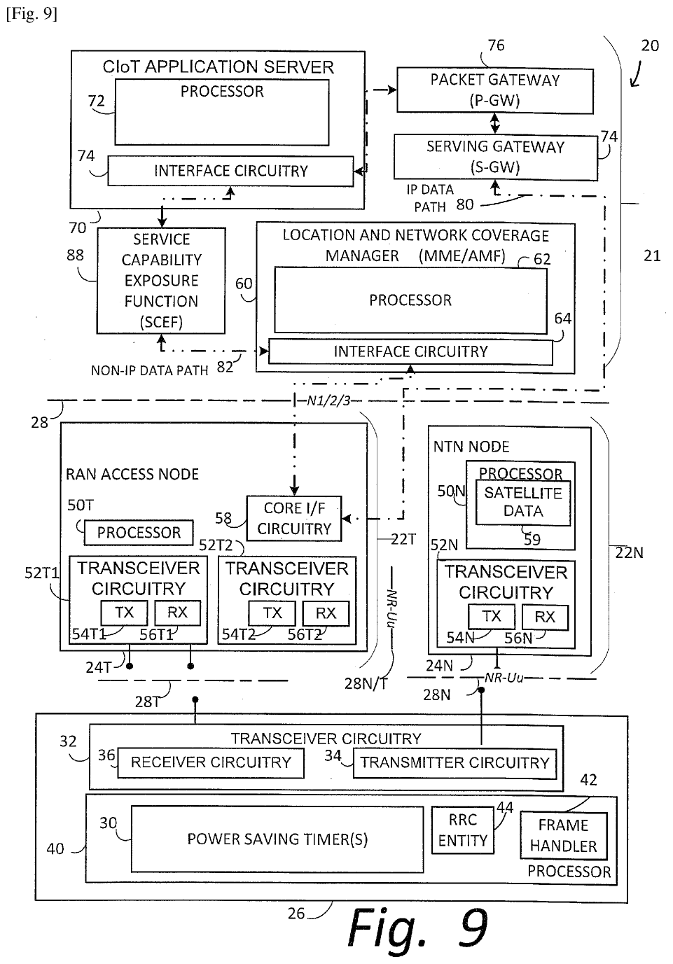

The wireless terminal 26 also comprises terminal transceiver circuitry 32, which in turn comprises terminal transmitter circuitry 34 and terminal receiver circuitry 36. The transceiver circuitry 32 includes antenna (e) for the wireless terminal 26. Transmitter circuitry 34 includes, e.g., amplifier(s), modulation circuitry and other conventional transmission equipment. Receiver circuitry 36 comprises, e.g., amplifiers, demodulation circuitry, and other conventional receiver equipment. The transceiver circuitry 32 is configured to use resources for communication with one or more radio access networks 22. FIG. 9 particularly shows two radio access networks 22T and 22N. Radio access network 22T is a terrestrial radio access network such as an E-UTRAN network and/or New Radio 5G network. Radio access network 22N is a non-terrestrial radio network 22N of a type described, for example, in 3GPP 28.808, incorporated herein by reference.

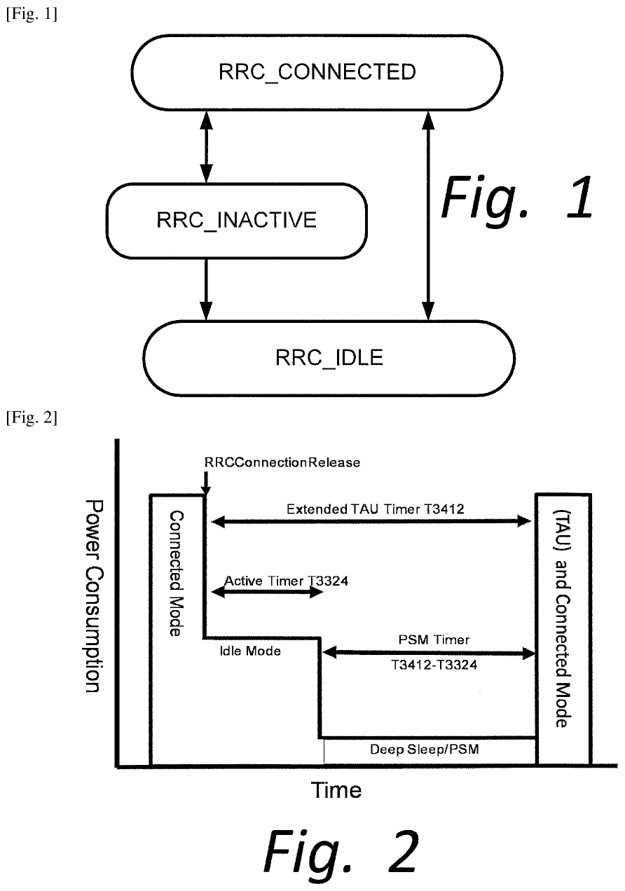

The wireless terminal 26 further comprises processor circuitry, also herein known more simply as UE processor 40, or simply as terminal processor 40 or processor 40. While processor 40 may have responsibility for operation of many aspects of wireless terminal 26 not specifically described herein, in one of its aspects the processor 40 serves comprising and/or interacting, e.g., setting value(s) for, power saving timer 30. The processor 40 may also comprise, or work in conjunction with, frame handler 42 and radio resource control (RRC) entity 44. The radio resource control (RRC) entity 44 operates as the RRC state machine described above, e.g., with reference to FIG. 1.

As mentioned above, radio access network (RAN) 22 comprises two radio access networks, e.g., terrestrial radio access network 22T and non-terrestrial radio network 22N. Any reference to “radio access network” herein may collectively refer to both terrestrial radio access network 22T and non-terrestrial radio network 22N since, e.g., communications routed through non-terrestrial radio network 22N are also routed through terrestrial radio access network 22T. Each radio access network comprises one or more access nodes, one such access node 24T being shown in FIG. 9 for terrestrial radio access network 22T and one example access node 24N being shown for non-terrestrial radio network 22N. An access node 24N for non-terrestrial radio network 22N preferably takes the form of, or is hosted or carried by, a satellite. As indicated above, depending on radio access technology and generation, the access node 24T may have any of several names, and accordingly, as shown in FIG. 5 and FIG. 9, may be referred to as an eNodeB, e.g., eNB, or, for 5G or New Radio, as gNB.

Both access node 24T and access node 24N comprises node processor circuitry, simply referred to as access node processors 50T and 50N, respectively, as well as access node transceivers. From FIG. 9 it can be seen that wireless terminal 26 communicates over radio interface 28T with the access node 24T of terrestrial radio access network 22T, and over radio interface 28N with the access node 24N of terrestrial radio access network 22N. The access node 24N of non-terrestrial radio network 22N communicates over radio access interface 22N/T with the access node 24T of terrestrial radio access network 22T. Each of the access nodes comprises one or more transceivers. For example, access node 24T is shown as comprising transceiver 52T1 for communicating over the radio interface 28T with wireless terminal 26, and transceiver 52T2 for communicating over the radio interface 28N/T with access node 24N. Each access node transceiver 52 comprises node transmitter circuitry 54 and node receiver circuitry 56. The access node 24T also comprises core network interface circuitry 58 for communicating with core network 21.

The wireless terminal 26 may communicate with one or both of terrestrial radio access network 22T and non-terrestrial radio network 22N. A network may inform a wireless terminal that it is a non-terrestrial network by an appropriate indicator in system information or the like, e.g., in an appropriate system information block, SIB, e.g., such as a Master System Information Block MIB or SIB1. As used herein, the phrase “via the radio access network” may mean either via the terrestrial radio access network 22T or via the non-terrestrial radio network 22N. In at least some implementations and operations, the wireless terminal 26 may primarily or even exclusively communicate through non-terrestrial radio network 22N, for which reason the fact and timing of coverage of the non-terrestrial radio network 22N, which may be transitory as explained above, is important. As also mentioned above, the coverage or non-coverage of the non-terrestrial network may affect timers of the wireless terminal 26, and whose operation in turn affects battery utilization.

As mentioned above, the access node 24N may be a satellite. For example, the access node 24N may be a LEO, MEO or GEO satellite and can either be working in transparent mode or in regenerative mode.

When a satellite is configured in transparent mode, no data processing will be done locally in the satellite. The incoming signal will be received, amplified, and transmitted back to earth, e.g., back to an access node of a terrestrial radio access network 22T such as access node 24T shown in FIG. 9. Thus, transparent satellite may be coupled to a gNB which is located on earth, and the gNB, such as access node 24T. The access node 24T will use a satellite gateway, represented by transceiver 52T2, to transmit to the satellite which reflects the signal back to earth. Thus, if the access node 24N satellite is transparent, New Radio (NR) signals are generated from gNBs comprising a satellite enabled NR-RAN that are located on ground. The transparent satellite is equivalent to a Radio Frequency (RF) Remote Unit, and is full transparent to the New Radio protocols, including the physical layer.

A regenerative satellite may actually demodulate/decode and process the incoming signal before sending data back to earth. Such actions may be performed, for example, by node processor 50N of the access node 24N. A regenerative satellite may therefore embark a gNB/gNB-DU/gNB-CU and even use inter-satellite links to communicate with other satellite gNBs. In one example implementation of a regenerative access node 24N, the satellite payload implements a gNB distributive unit, DU, as part of a satellite enabled NR-RAN. Some of the protocols of the NR are processed by the satellite. A Satellite Radio Interface (SRI) transports the F1 protocol between the on-ground CU and the on-board DU. In another example implementation, the satellite payload implements a full gNB supporting a satellite enabled NR-RAN. A Satellite Radio Interface (SRI) transports the N1/N2/N3 interfaces between the on-ground 5G CN and the on-board gNB central/control unit, CU.

The technology disclosed herein may be applicable to implementations of both transparent and regenerative access node 24Ns, e.g., may be utilized in or with either transparent and regenerative access node 24Ns. Moreover, the access node 24Ns disclosed herein are capable of maintaining and providing satellite data by which another entity, e.g., a terrestrial entity such as wireless terminal 26 or a access node 24T, may calculate coverage time, and conversely non-coverage time, of the access node 24N with respect to that other entity. FIG. 9 thus shows node processor 50N of access node 24N as comprising satellite data provider 59. As used herein, “satellite data” includes any information that may be used by another entity to determine a parameter, characteristic, or path of travel of the access node 24N including, for example, orbital data and other ephemeris data that may be used to calculate the coverage of the access node 24N or an aspect of the non-terrestrial radio network 22N to which the access node 24N belongs. For example, another node, such as wireless terminal or terrestrial radio access network 22T, may receive and use satellite data such as orbital and possibly other ephemeris data to calculate NTN coverage information.

The core network 21 is shown in more detail in FIG. 9 as comprising various nodes and functionalities, including location and network coverage manager 60. The location and network coverage manager 60 manages location and network coverage information, and for some networks may take the form of an LTE Mobility Management Entity, MME, while in New Radio, NR, the location and network coverage manager 60 may take the form of an Access and Mobility Management Function, AMF. Therefore in FIG. 9 the location and network coverage manager 60 is labeled as MME/AMF 60. As used herein, any reference to “MME” or “AMF” should be understood to generically refer to the location and network coverage manager 60, unless otherwise noted or understood from the context. The location and network coverage manager 60 includes manager processor 62 and manager interface(s) 64.

As further shown in FIG. 9 the core network 21 also comprises application server 70. The application server 70 may serve any appropriate supporting function for any node of the communications system 20. For example, application server 70 may serve as an application server for CIoT devices, such as eMTC and NB-IoT devices, and thus for sake of convenience only is labeled in FIG. 9 as CIoT application server 70. It should be understood that application server 70 may be referred to by other names, and that application server 70 may stand alone as one or more distinct nodes of core network 21, or be included with or subsumed in one or more other nodes of core network 21 which serve other or additional functions. The CIoT application server 70 may analyze data for CIoT devices. Multiple wireless terminals, e.g., multiple CIoT devices, may be connected to a single CIoT application server 70. As shown in FIG. 9, CIoT application server 70 comprises application server processor circuitry, e.g., application server processor 72, and application server interface circuitry 74.

Between radio access network (RAN) 22T and CIoT application server 60 there is both an IP data path 70 and a non-IP data path 72 through core network 21. IP data path 70 is shown by a dashed/single dotted line in FIG. 3; the non-IP data path 72 is shown by a dashed/double dotted line in FIG. 3. For the IP data path 70, the node interface circuitry 58 of access node 24 connects to serving gateway (S-GW) 74, which in turn connects to packet gateway (P-GW) 76. The packet gateway (P-GW) 76 connects to application server interface circuitry 64. For sake of simplicity, one or more of the data paths shown in FIG. 9 may not be shown in the figures for other embodiment and modes

The non-IP data path 72 is employed for non-IP data delivery (NIDD). For the non-IP data path 72, the node interface circuitry 58 of access node 24 connects to location and network coverage manager 60. The location and network coverage manager 60 comprises, e.g., manager processor 62 and manager interface(s) 64. The manager interface(s) 64 connects to node interface circuitry 58 of access node 24 and to Service Capability Exposure Function (SCEF) 88. The manager interface(s) 64 is also connected to the application server interface circuitry 64 of CIoT application server 60.

FIG. 9 also illustrates, for an example scenario, an uplink data flow between the terrestrial radio access network 22T and the core network. Data packets are separated into Non IP and IP data, e.g., to non-IP data path 82 and IP data path 80. The non IP data is routed on non-IP data path 82 to location and network coverage manager 60, and then to Service Capability Exposure Function, SCEF, 88, and then to CIoT application server 70. The IP data is routed on IP data path 70 via serving gateway (S-GW) 84 and packet gateway (P-GW) 86 to CIoT application server 70.

The Service Capability Exposure Function (SCEF) 88 may comprise one or more stand-alone or dedicated node(s) or may comprise or be subsumed in another node of core network 21. The role of SCEF (Service Capability Exposure Function) 88 is basically defined in 3GPP 23.682, Non-IP Data Delivery (NIDD) using Service Capability Exposure Function (SCEF). The contents of NIDD may include data from devices such sensor readings, location and more. The data may be processed, for example, by the CIoT application server 70. One of the SCEF features provides a means to access and expose network capabilities. Network capabilities may include Group message delivery, Monitoring of events, Resource management of background data transfer, and Network parameter configuration. The functions of Service Capability Exposure Function (SCEF) 88 may be performed by, e.g., executed on, processor circuitry of the node that hosts Service Capability Exposure Function (SCEF) 88. The Service Capability Exposure Function (SCEF) 88 is connected to non-IP data path 82 to application server interface circuitry 74 of CIoT application server 60. In this regard, a T6a/T6b connection may be used between Service Capability Exposure Function (SCEF) 88 and CIoT application server 70.

While uplink data transfer has been described above, it should also be mentioned that network parameter information is transferred on a downlink, e.g., in a direction from CIoT application server 70 to Service Capability Exposure Function (SCEF) 88.

Various example aspects of the technology disclosed herein are described below in separately enumerated sections. It should be understood, however, that the various aspects, or portions thereof, may be used in combination with other aspects.

### 1.0: Wireless Terminal Sending Adjusted Power Saving Timer to the Network

In one of its example aspects the technology disclosed herein encompasses example embodiments and modes in which a wireless terminal sends one or more adjusted power saving timers to the network, e.g., to the core network. As used herein, “sends adjusted power saving timers to the network” includes sending one or more adjusted value(s) for the power saving timers of the wireless terminal. Such adjusted value(s) may comprise one or more of (1) timer values which the wireless terminal requests and expects the core network to use for one or more of the power saving timer(s) of the wireless terminal; (2) timer values that the wireless terminal recommends that the core network use for the power saving timer (s (3) timer value information which the wireless terminal provides for the core network so that the core network may use the timer value information to generate, update revise, or re-calculate a timer value for the power saving timer that will be understood by both the network and the wireless terminal and used by the wireless terminal; and (4) a timer request flag.

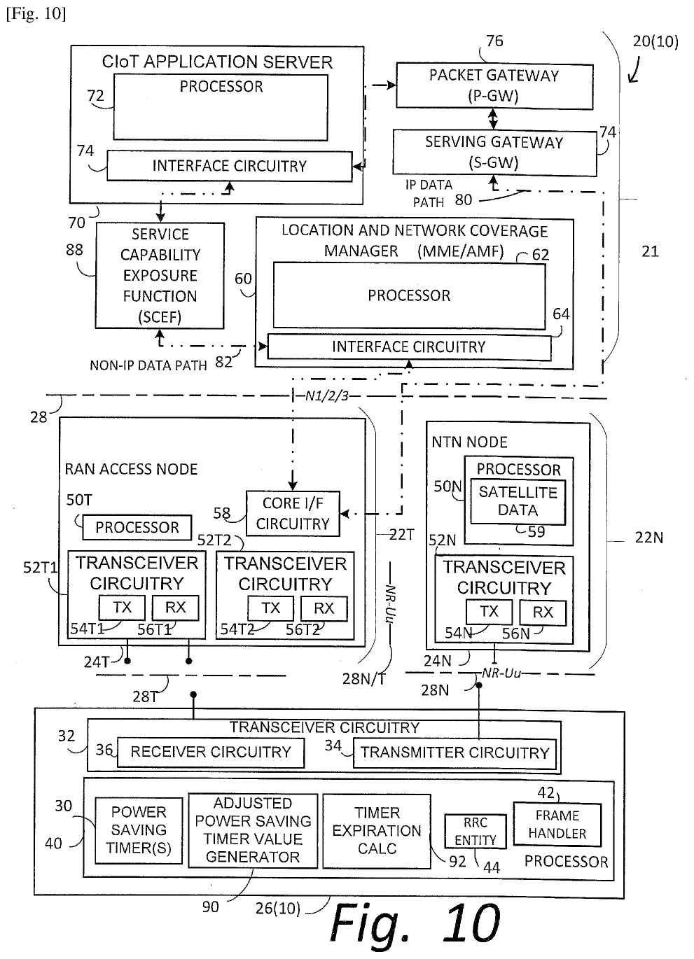

An example communications system 20(10) in which wireless terminal 26(10) sends one or more adjusted power saving timers to the network. As such, the wireless terminal 26(10) includes timer expiration calculator 90 and adjusted power saving timer value generator 92, either or both of which may comprise or be realized by terminal processor 40. The nodes, structures, and functionalities of FIG. 10 are the same as those of the generic example embodiment and mode of FIG. 9 unless otherwise indicated, particularly for elements having like reference numbers.

The wireless terminal 26(10) of FIG. 10 communicates over a radio interface with a radio access network and comprises a power saving timer 30, terminal processor circuitry 40, and terminal transmitter circuitry 34. The power saving timer 30 is configured to establish duration of one or more operational modes of the wireless terminal, each of the operational modes being associated with a power utilization level by the wireless terminal. The terminal processor circuitry 40 is configured to determine an adjusted timer value for the power saving timer. The adjusted timer value is preferably based on non-terrestrial network (NTN) coverage information for the wireless terminal. For example, as explained above, the wireless terminal 26(10) may derive NTN satellite coverage pass time (start/stop times) from orbital data downloaded by satellites, as provided by satellite data provider 59. The UE will may take satellite data such as orbital and optionally other ephemeris data to calculate NTN coverage information.

As mentioned above, terminal processor circuitry 40 may be configured to determine an adjusted timer value for the power saving timer. Such determination may include full or partial delegation of calculations or processing actions to a server in communication with the wireless terminal. Such server may include, for example, the applications server 70 or any other device with which the wireless terminal communicates.

The terminal transmitter circuitry 34 is configured to transmit the adjusted timer value(s) for the power saving timer via the radio access network 22, most likely non-terrestrial radio network 22N, to a core network node, such as location and network coverage manager 60. A purpose of the transmission of the adjusted timer value(s) to the core network node is so that the core network node can either adopt the adjusted timer value(s) for its own use in coordinating operations and communications with the wireless terminal 26(10), or so that core network node can use the adjusted timer value(s) as input as the core network node makes its own definitive determination as to what the correct timer value should be for the power saving timer of the wireless terminal 26(10).

An “operational mode” is understood with reference to FIG. 2 to be one of the connected mode, idle mode, and power saving mode (PSM) or deep sleep mode. Two example power saving timers described herein as standardized or pre-established timers are the T3412 timer, also known as the T3412 timer extended tracking area update timer, and the T3324 timer. The T3324 timer establishes duration of the idle mode and is associated with an idle mode power level, which is intermediate the power level of the connected mode and the power level of the power saving mode (PSM). The T3412 timer establishes duration of the power saving mode (PSM), it being understood that while the T3412 timer covers both the idle mode and the power saving mode (PSM), by subtracting the duration of the idle mode, i.e., the value of the T3324 timer, the duration of the power saving mode (PSM) is established. Thus, the T3412 timer may be said to establish duration of two modes, both the idle mode and the power saving mode (PSM) but can also be said to establish duration of the power saving mode (PSM) when subtracting the duration of the idle mode. The idle mode and the power saving mode (PSM) each have a different power utilization level, the power utilization of the power saving mode (PSM) being less than that of the idle mode, as understood from FIG. 2.

In the example embodiment and mode of FIG. 10, wireless terminal 26(10), e.g., timer expiration calculator 90, determines that one of the current timers, either T3412, T3324, or eDRX, may expire during NTN Gap Period. In connection with such determination, wireless terminal 26(10) may receive location assistance data, such as satellite ephemeris, from which the wireless terminal 26(10) may calculate or derive NTN coverage and Gap Periods. Moreover, as explained herein, wireless terminal 26(10) may also receive from the network, a validity timer that can be used to determine the end of NTN Coverage Period or the beginning of NTN Gap Period. As used herein, a “validity timer” defines a time duration when at least satellite ephemeris information is valid. The validity timer may be used for UL synchronization and GNSS measurement for sporadic short transmission. Then, while in connected and idle mode, wireless terminal 26(10) may determine that expiry of current timers, T3412, T3324 with optional eDRX, may occur during an NTN Gap Period. As a result of such determination, the wireless terminal 26(10) may adjust one or more of the timers to ensure that expiry of a power saving timer does not happen during NTN Gap Period. The timer expiration calculator 90 may be used to make the determination of expiry of one or more of the current timers; the adjusted power saving timer value generator 92 may generate an adjusted power saving value. The adjusted power saving value may be transmitted to the network by the terminal transmitter circuitry 34 of wireless terminal 26(10).

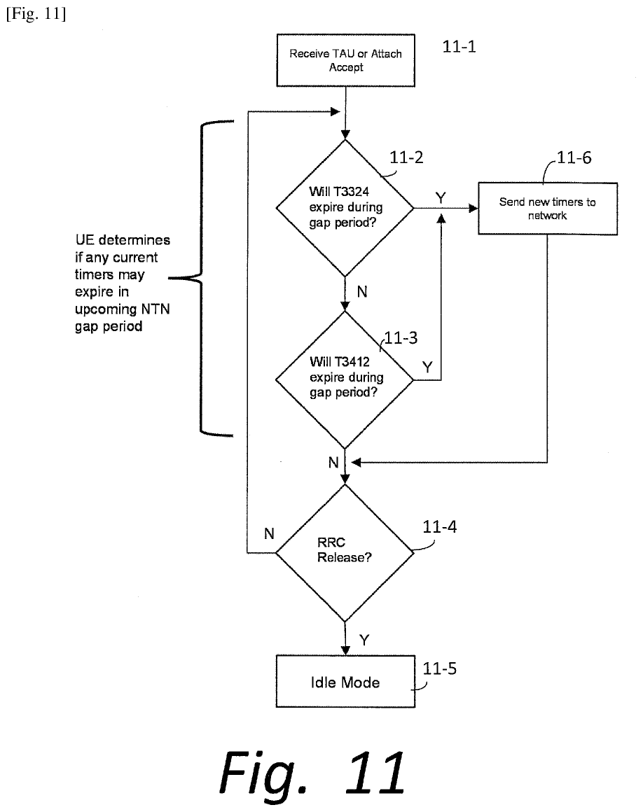

FIG. 11 illustrates example acts or modes performed by the wireless terminal 26(10) of FIG. 10. The acts of FIG. 11 may be performed by terminal processor 40 including timer expiration calculator 90 and adjusted power saving timer value generator 92. Act 11-1 comprises receiving a tracking area update message or an attach accept message. Act 11-2 is executed after act 11-1 and comprises determining if the T3324 timer will expire during a gap period. If the determination of act 11-2 is negative, as act 11-3 the timer expiration calculator 90 determines if the T3412 timer will expire during the gap period. If the determination of act 11-3 is negative, the wireless terminal 26(10) determines if the connection is to be released, e.g., if an RRC Connection Release message has been received. If the determination of act 11-4 is negative, execution returns to act 11-2, otherwise the connection is released and the wireless terminal 26(10) enters idle modes as illustrated in act 11-5. If the determination of either act 11-2 or act 11-3 is positive, as act 11-6 the wireless terminal 26(10) generates and sends one or more adjusted value(s) for the power saving timers of the wireless terminal to the network. After execution of act 11-5, the wireless terminal 26(10) executes act 11-4.

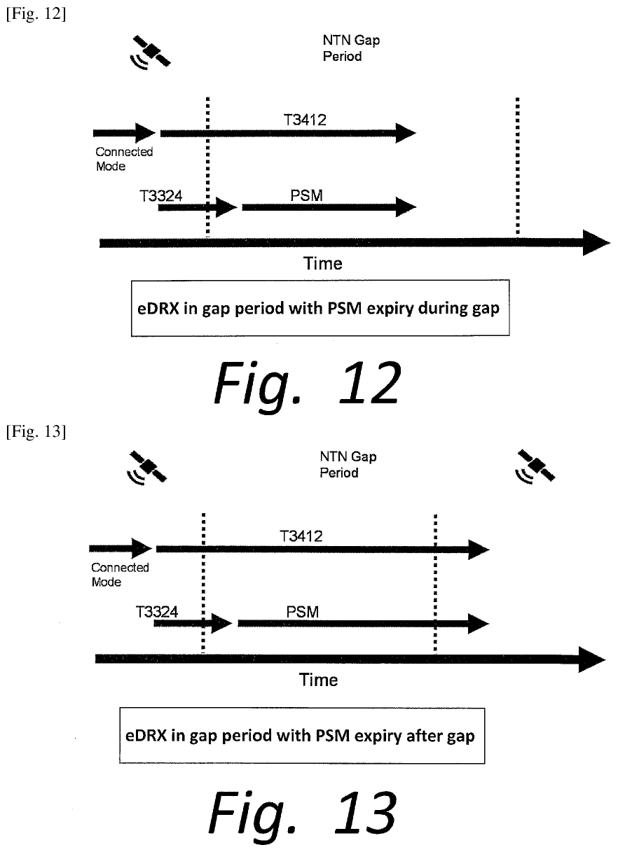

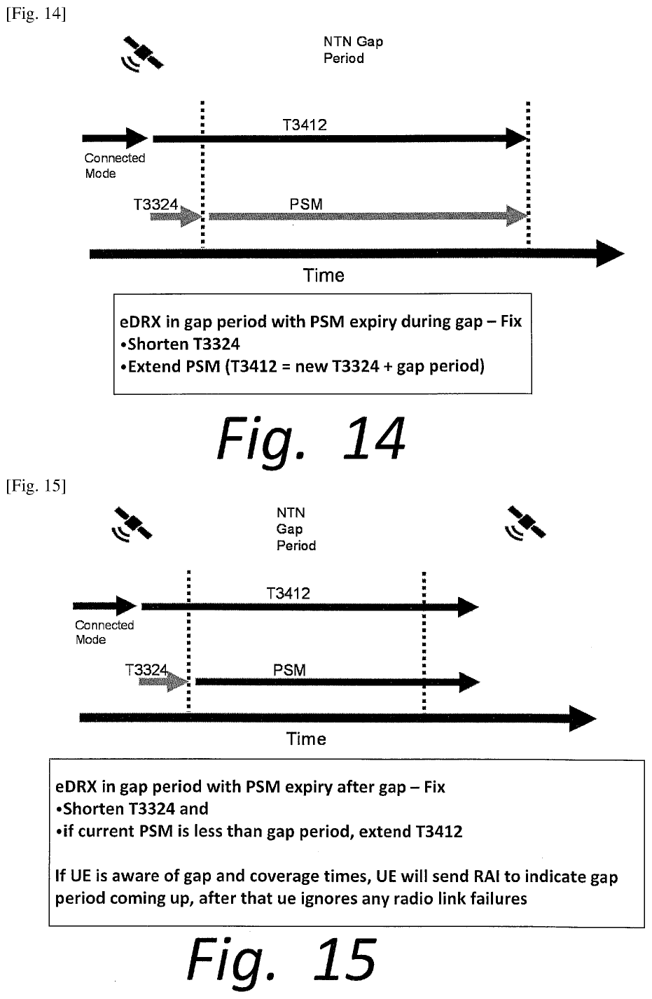

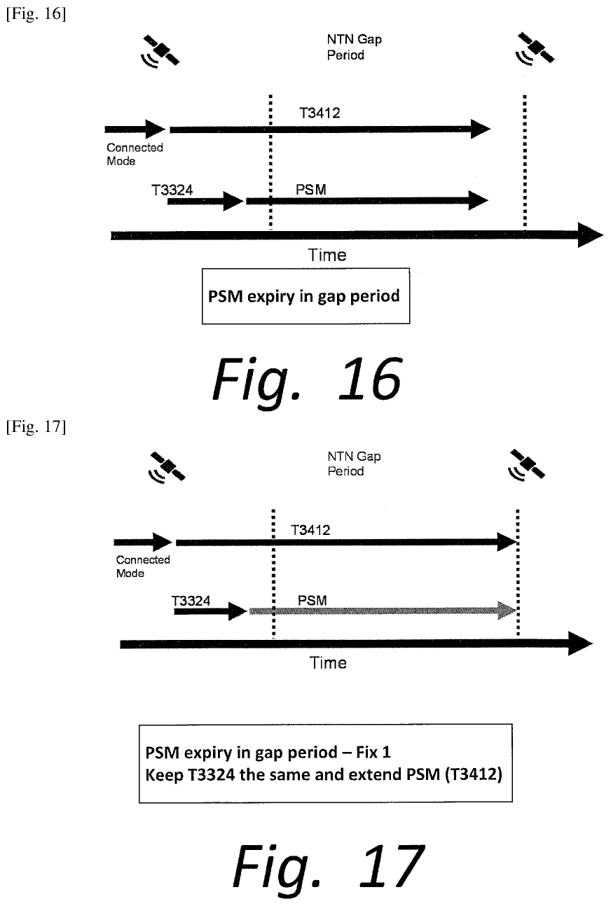

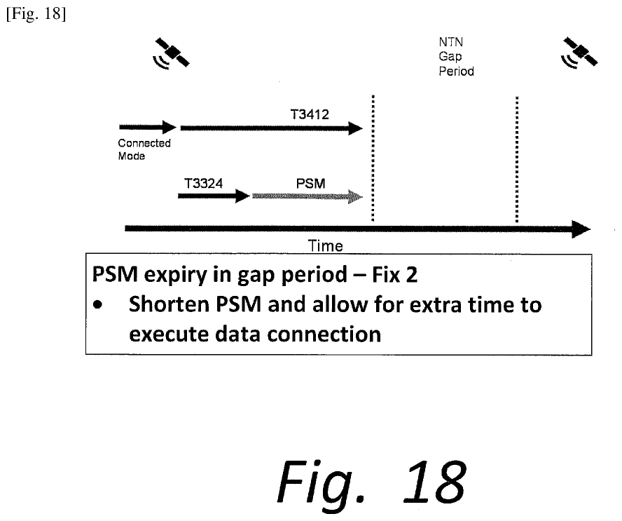

Example scenarios in which the acts or steps of FIG. 11 may be implemented are illustrated below with reference to FIG. 12-FIG. 18. FIG. 12, FIG. 13 and FIG. 16 particularly show problem situations, and corresponding FIG. 14, FIG. 15, FIG. 17, and FIG. 18 show how wireless terminal 26(10) may prepare adjusted timer values to resolve the problematic situations.

If the wireless terminal 26(10) determines that T3324 timer may expire during NTN Gap Period, as in the cases illustrated in FIG. 12 and FIG. 13, then the T3324/eDRX timers are shortened. To determine if the T3324 timer expires during NTN Gap Period, the wireless terminal 26(10) may add the current T3324 timer value to the current date and time. If the result is within the time and date of NTN Gap Period, adjustments are made to T3324 to ensure timer does not expire during NTN Gap Period.

Current date/time may also be added to the T3412 timer to determine if T3412 adjustment is necessary. FIG. 12 may represent timer T3324 and timer T3412 expiring in NTN Gap Period. To correct these issues, the T3324 timer value may be reduced so that the expiry matches the start time of NTN Gap Period, as shown in FIG. 14. The new T3324 value is then the duration between current time and start of NTN Gap Period.

In FIG. 13, the T3324 timer expires during the NTN Gap Period but the T3412 timer expires in the NTN Coverage Period. The issue of FIG. 13 may be resolved by reducing the value of timer T3324. If wireless terminal 26(10) decides that the timer T3412 value should not change, then the new PSM value is the difference between T3412 timer value and new T3324, as illustrated in FIG. 15. Otherwise, the T3412 timer may expire at the end of NTN Gap Period.

The wireless terminal 26(10) may determine that timer T3412 (PSM) expires during NTN Gap Period, in the situation illustrated by FIG. 16. In the case of FIG. 16, the wireless terminal 26(10) may modify the timer T3412 value but the timer T3324 value will remain the same, with the timer T3412 value being extended until the start time of next NTN Coverage Period as shown in FIG. 17.

The wireless terminal 26(10) may extend the timer T3324 until the start of the NTN Gap Period and so that the timer T3412 expiry matches the start of next NTN Coverage Period, as illustrated in FIG. 18.

An example Information Element (IE) which may be used by the wireless terminal 26(10) for sending UE updated or adjusted timers, e.g., timer values, may be of the type shown in Error! Reference source not found. 1. In conjunction with Table 1, non-access stratum, NAS, signaling may be used with Uplink data transfer. The Uplink data encapsulated in an NAS message allows wireless terminal 26(10) to send at any time during connected mode without a request from network. The RRC message, ULInformationTransfer-NB, for which an example is shown in the listing of Table 2, may be used for transferring NAS information via an information element DedicatedInfoNAS, an example of which is shown in the listing of Table 3. The NAS ESM DATA TRANSPORT message is used for sending information to MME.

TABLE 1
Uplink ESM DATA TRANSPORT message content

| | Information | | Pres- | For- | |
|---|---|---|---|---|---|
| IEI | Element | Type/Reference | ence | mat | Length |
| | Protocol | Protocol | M | V | ½ |
| | discriminator | discriminator | | | |
| | | 9.2 | | | |
| | EPS bearer identity | EPS bearer identity | M | V | ½ |
| | | 9.3.2 | | | |
| | Procedure | Procedure transaction | M | V | 1 |
| | transaction | identity | | | |
| | identity | 9.4 | | | |
| | ESM data transport | Message type | M | V | 1 |
| | message identity | 9.8 | | | |
| | User data container | User data container | M | LV-E | 2-n |
| | | 9.9.4.24 | | | |
| | UE Updated T3412 | | O | TLV | 3 |
| | UE Updated T3324 | | O | TLV | 3 |
| | UE Updated eDRX | | O | TLV | 3 |

TABLE 2

| --ASN1START | |
|---|---|
| ULInformationTransfer-NB ::= SEQUENCE { | |
| criticalExtensions | CHOICE { |
| ulInformationTransfer-r13 | |
| ULInformationTransfer-NB-r13-IEs, | |
| criticalExtensionsFuture | SEQUENCE { } |
| } | |
| } | |
| ULInformationTransfer-NB-r13-IEs ::=SEQUENCE { | |
| dedicatedInfoNAS-r13 | |
| DedicatedInfoNAS, | |
| lateNonCriticalExtension OCTET STRING | |
| OPTIONAL, | |
| nonCriticalExtension | SEQUENCE { } |

OPTIONAL
}

TABLE 3

-- ASN1START
DedicatedInfoNAS ::= OCTET STRING
-- ASN1STOP

The reference to ESM DATA TRANSPORT and CIoT is in 24.301 is reproduced in Table 4, from which it is emphasized that a UE using EPS services with control plane CIoT EPS optimization can initiate transport of user data via the control plane. For this purpose a UE in EMM-IDLE mode can initiate the service request procedure and transmit the ESM DATA TRANSPORT message in an information element in the CONTROL PLANE SERVICE REQUEST message.

TABLE 4
“4.2 Linkage between the protocols for EPS mobility management and
EPS session management
During the EPS attach procedure, the network can activate a
default EPS bearer context (i.e. if the UE requests PDN
connectivity in the attach request). Additionally, the
network can activate one or several dedicated EPS bearer
contexts in parallel for PDN connections of IP or Ethernet
PDN type. To this purpose the EPS session management messages
for the default EPS bearer context activation can be
transmitted in an information element in the EPS mobility
management messages. In this case, the UE and the network
execute the attach procedure, the default EPS bearer context
activation procedure, and the dedicated EPS bearer context
activation procedure in parallel. The UE and network shall
complete the combined default EPS bearer context activation
procedure and the attach procedure before the dedicated EPS
bearer context activation procedure is completed. If EMM-
REGISTERED without PDN connection is not supported by the UE
or the MME, then the success of the attach procedure is
dependent on the success of the default EPS bearer context
activation procedure. If the attach procedure fails, then the
ESM procedures also fail.
A UE using EPS services with control plane CIOT EPS
optimization can initiate transport of user data via the
control plane. For this purpose a UE in EMM-IDLE mode can
initiate the service request procedure and transmit the ESM
DATA TRANSPORT message in an information element in the
CONTROL PLANE SERVICE REQUEST message.
Except for the attach procedure and the service request
procedure, during EMM procedures the MME shall suspend the
transmission of ESM messages. During the service request
procedure, the MME may suspend the transmission of ESM
messages.
Except for the attach procedure and the service request
procedure for UE initiated transport of user data via the
control plane, during EMM procedures the UE shall suspend the
transmission of ESM messages.”

### 2.0: Network Sends Adjusted Power Savings Adjustment to Wireless Terminal

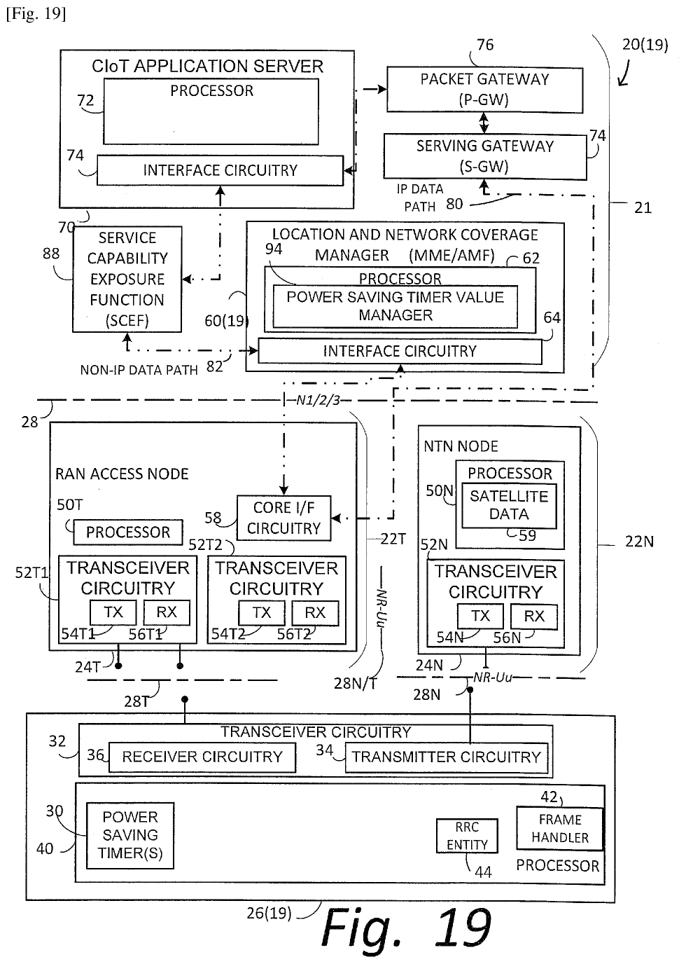

In one of its example aspects the technology disclosed herein encompasses example embodiments and modes in which the core network, e.g., a core network node, sends one or more power saving timer values, e.g., adjusted power saving timers, e.g., one or more adjusted power saving timer values, to the wireless terminal. FIG. 19 shows an example of a communications system in which core network 21, and particularly the location and network coverage manager 60(19), generates and/or sends one or more adjusted power saving timer values to the wireless terminal 26(19). In the example embodiment and mode of FIG. 19, the NTN coverage and Gap Periods are known and managed by network. Such knowledge by the network may be based on information provided by the satellites, e.g., access nodes 24N, and may be stored in satellite data provider 59. For example, the various satellites may communicate their location information to a central server which may comprise or be connected to the location and network coverage manager 60(19), e.g., to MME/AMF. In some example embodiment and mode a Service Capability Exposure Function (SCEF) 88 may be used to transport data between the central server and MME/AMF. Alternatively or additionally that the satellites may communicate to location and network coverage manager 60, MME/AMF directly, or using the Service Capability Exposure Function (SCEF) 88 as transport mechanism.

In the example embodiment and mode of FIG. 19, the manager processor 62 of location and network coverage manager 60(19) includes a power saving timer value manager 94 which either calculates or generates a timer value for one or more of the power saving timers, or alternatively includes a timer value received from another source in a message for transmission to the wireless terminal 26. Such timer value may be referred to herein as an updated timer value and/or a re-calculated timer value. In a situation in which another source which may actually perform the calculation or may generate a power saving timer value which the power saving timer value manager 94 receives and includes in a message to the wireless terminal, such other sources may be other core network nodes or servers. The nodes, structures, and functionalities of FIG. 19 are the same as those of the generic example embodiment and mode of FIG. 9 unless otherwise indicated, particularly for elements having like reference numbers.

The example embodiment and mode of FIG. 19 thus includes a node of a core network of a telecommunications system, such as core network node 60(19). The core node comprises node processor circuitry and node interface circuitry. The processor circuitry is configured to set or adjust a timer value for a power saving timer of the wireless terminal 26(19) served by the core network. The timer value is based on non-terrestrial network (NTN) coverage information for the wireless terminal. The interface circuitry is configured to transmit a message including the timer value to a radio access network which serves the wireless terminal.

The example embodiment and mode also include wireless terminal 26(19) which communicates over a radio interface with a radio access network. The wireless terminal comprises power saving timer 30 and terminal receiver circuitry 36. The power saving timer is configured to establish duration of one or more operational modes of the wireless terminal, each operational mode being associated with a respective power utilization level by the wireless terminal. The receiver circuitry is configured to receive, via the radio access network and from a core network node, a timer value for the power saving timer, the timer value being based on non-terrestrial network (NTN) coverage information for the wireless terminal. The wireless terminal also comprises processor circuitry 40 which may operate and indeed may comprises the power saving timer 30.

In a method of operation, the wireless terminal 26(19) thus receives, via the radio access network and from a core network node, a timer value for the power saving timer, and uses the timer value to operate the power saving timer and thereby establish duration of one or more operational modes of the wireless terminal. As explained above, each operational mode is associated with a respective power utilization level by the wireless terminal, and the timer value is based on non-terrestrial network (NTN) coverage information for the wireless terminal.

Thus, in the example embodiment and mode of FIG. 19 the network may initiate and convey or respond to the wireless terminal 26 with updated timer values, e.g., T3412, T3324, eDRX. The updated timers, e.g., the updated timer values may be included as NAS DL Information in a DedicatedInfoNAS message. DedicatedInfoNAS may be encapsulated as part of DLInformation Transfer/DLInformation Transfer-NB, as illustrated by and understood with respect to Table 5.

TABLE 5

| -- ASN1START | |
|---|---|
| DLInformationTransfer-NB ::= SEQUENCE { | |
| rrc-TransactionIdentifier RRC- | |
| TransactionIdentifier, | |
| criticalExtensions | CHOICE { |
| c1 | CHOICE { |
| dlInformationTransfer-r13 | |
| DLInformationTransfer-NB-r13-IEs, | |
| spare1 NULL | |
| }, | |
| criticalExtensionsFuture | SEQUENCE { } |
| } | |
| } | |
| DLInformationTransfer-NB-r13-IEs ::= | SEQUENCE { |
| dedicatedInfoNAS-r13 | |
| DedicatedInfoNAS, | |
| lateNonCriticalExtension | OCTET STRING |
| OPTIONAL, | |
| nonCriticalExtension | SEQUENCE { } |

OPTIONAL
}
-- ASN1STOP

If duration of timers T3412 or T3324 added to current date/time is within the NTN Gap Period, the network may recalculate and send the adjusted timer values. Such calculation, or recalculation of adjusted timers may occur in MME/AMF, e.g., in the power saving timer value manager 94 of location and network coverage manager 60(19), or in another node such as an application server, e.g., application server 70, using SCEF 90, e.g., communicating via timer expiration calculator 90.

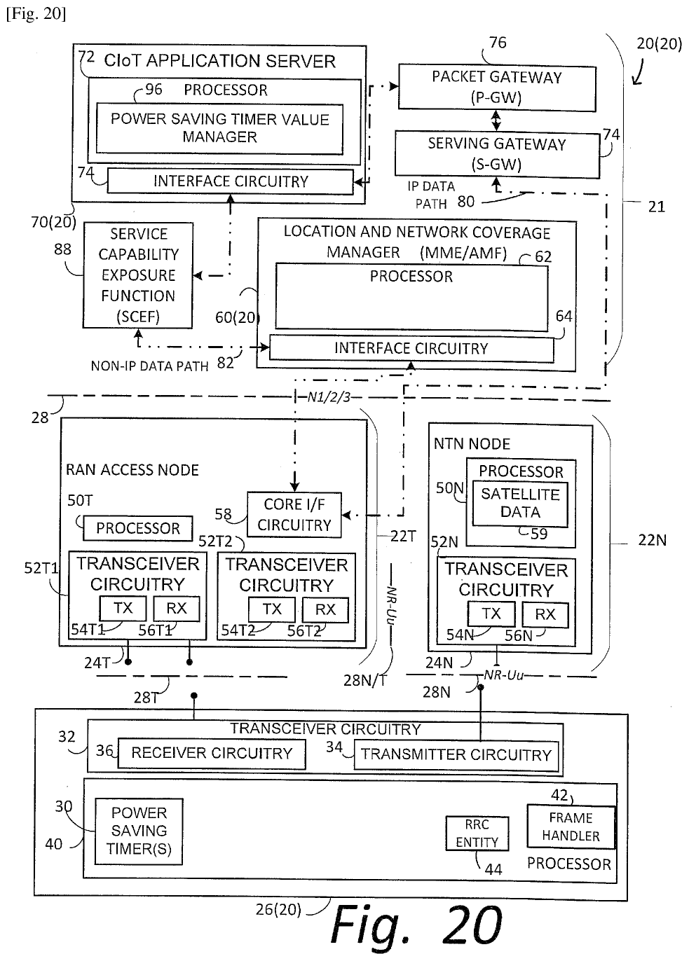

FIG. 20 shows an example embodiment and mode wherein the application server 70(20) includes power saving timer value manager 96, which may comprise or be realized by application server processor 72. The power saving timer value generated by application server application server 70 are communicated to wireless terminal 26 through the radio access network(s) 22. The nodes, structures, and functionalities of FIG. 20 are the same as those of the generic example embodiment and mode of FIG. 9 unless otherwise indicated, particularly for elements having like reference numbers.

For the example embodiments and modes of FIG. 19 and/or FIG. 20, the adjusted power saving timer value sent to the wireless terminal may either be generated without a solicitation for the timer value by the wireless terminal, or may be in response to a request from the wireless terminal. These two cases are discussed in the following two subsections, which describe conditions which may trigger the network to send the adjusted timer values to wireless terminal.

### 2.1: Unsolicited Network Sends Adjusted Power Savings Adjustment to Wireless Terminal

A network may send new timer values, e.g., adjusted timer values, at any time during connected mode. The adjusted timer values may be generated either by location and network coverage manager 60(19) of FIG. 19 or the power saving timer value manager 96 of FIG. 20. The network need not wait for a timer request from the wireless terminal, but may send the adjusted timer values without prompting by the wireless terminal, e.g., at its own initiative or discretion. The network may send the timer values using NAS via DLInformationTransfer/DLInformationTransfer-NB. An example format of a downlink (response) ESM DATA TRANSPORT message content for conveying the new or adjusted timer values is shown in Table 6.

TABLE 6
Downlink (Response) ESM DATA TRANSPORT message content

| | | | Pres- | For- | |
|---|---|---|---|---|---|
| IEI | Information Element | Type/Reference | ence | mat | Length |
| | Protocol discriminator | Protocol | M | V | ½ |
| | | discriminator | | | |
| | | 9.2 | | | |
| | EPS bearer identity | EPS bearer identity | M | V | ½ |
| | | 9.3.2 | | | |
| | Procedure transaction | Procedure | M | V | 1 |
| | identity | transaction identity | | | |
| | | 9.4 | | | |
| | ESM data transport | Message type | M | V | 1 |
| | message identity | 9.8 | | | |
| | User data container | User data container | M | LV-E | 2-n |
| | | 9.9.4.24 | | | |
| | Network | | O | TLV | 3 |
| | Updated T3412 | | | | |
| | Network | | O | TLV | 3 |
| | Updated T3324 | | | | |
| | Network | | O | TLV | 3 |
| | Updated eDRX | | | | |

### 2.2: Solicited Network Sends Adjusted Power Savings Adjustment to Wireless Terminal

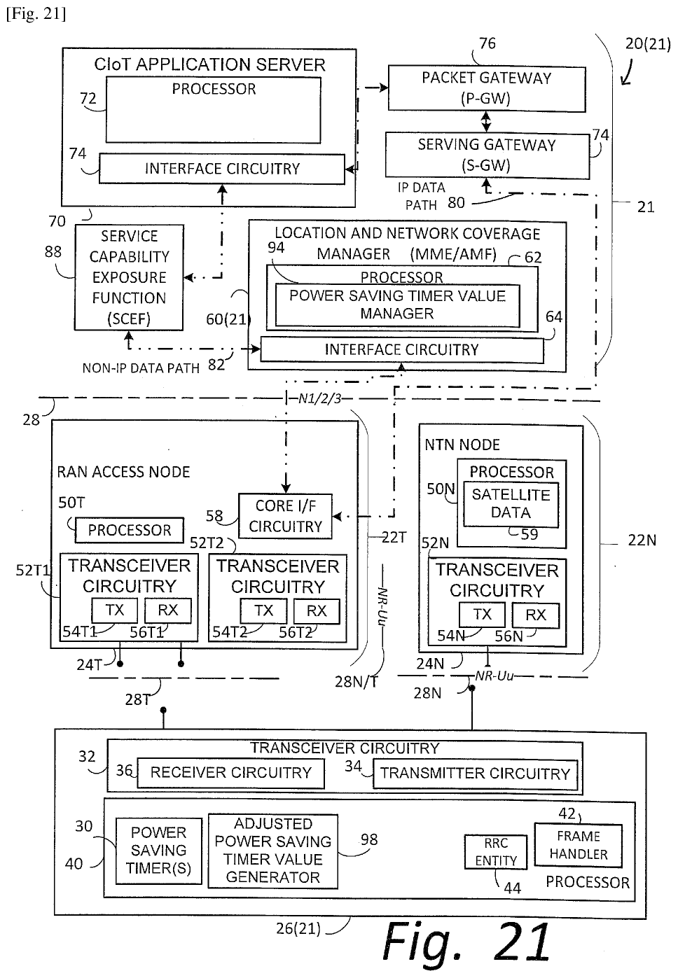

In another of its aspects, the core network may an adjusted timer value for the power saving timer in response to a request from a wireless terminal. FIG. 21 shows an example embodiment and mode in which wireless terminal 26(21) sends a request for an adjusted timer value, and the core network 21 responds accordingly. In particular, the in the situation shown in FIG. 21, an adjusted timer value request generator 98 of wireless terminal 26(21) generates the adjusted timer value request. The location and network coverage manager 60(21) responds with the adjusted timer value. The nodes, structures, and functionalities of FIG. 21 are the same as those of the generic example embodiment and mode of FIG. 9 unless otherwise indicated, particularly for elements having like reference numbers.

For the example embodiment and mode of FIG. 21, the wireless terminal 26(21) may request new timer values in an UL NAS message and the network may respond with timer values using a DL NAS message. An uplink data information element, IE, may contain a new flag that indicates a request for updated timer values, as understood with reference to the format of Table 7.

The timer request message from the wireless terminal 26(21) may also contain values for T3324, T3412, and eDRX IE. These timer values may be desired timer values that have been revised by the wireless terminal 26(19), specifically by a data application. As an example, if the wireless terminal 26(21) is a CIoT UE with sensor(s), the wireless terminal 26(21) may transmit UL IP data, e.g., measurements to an IoT server such as application server 70. The IoT server may respond back to the wireless terminal 26(21). Upon receipt of the response the wireless terminal 26(21) may process the response and determine that values for timer T3412 (PSM) and/or timer T3342 should be extended or shortened. The wireless terminal 26(21) and therefore calculated new timer values based on this determination, and then include the new desired timers calculated by the wireless terminal 26(21) in uplink data encapsulated in NAS UL message, understood with reference to Table 6. Once the network receives the request with desired timer(s) message, the core network performs a calculation to determine whether the desired timer values cause the timers to expire during the NTN Gap Period.

TABLE 7

| | | | Pres- | For- | |
|---|---|---|---|---|---|
| IEI | Information Element | Type/Reference | ence | mat | Length |
| | Protocol | Protocol | M | V | ½ |
| | discriminator | discriminator | | | |
| | | 9.2 | | | |
| | EPS bearer identity | EPS bearer identity | M | V | ½ |
| | | 9.3.2 | | | |
| | Procedure | Procedure | M | V | 1 |
| | transaction | transaction | | | |
| | identity | identity | | | |
| | | 9.4 | | | |
| | ESM data transport | Message type | M | V | 1 |
| | message identity | 9.8 | | | |
| | User data container | User data container | M | LV-E | 2-n |
| | | 9.9.4.24 | | | |
| | Request Timers Flag | | | | |
| | UE Desired T3412 | | O | TLV | 3 |
| | UE Desired T3324 | | O | TLV | 3 |
| | UE Desired eDRX | | O | TLV | 3 |

3.0: RRC Release Connection with NAS DL Data

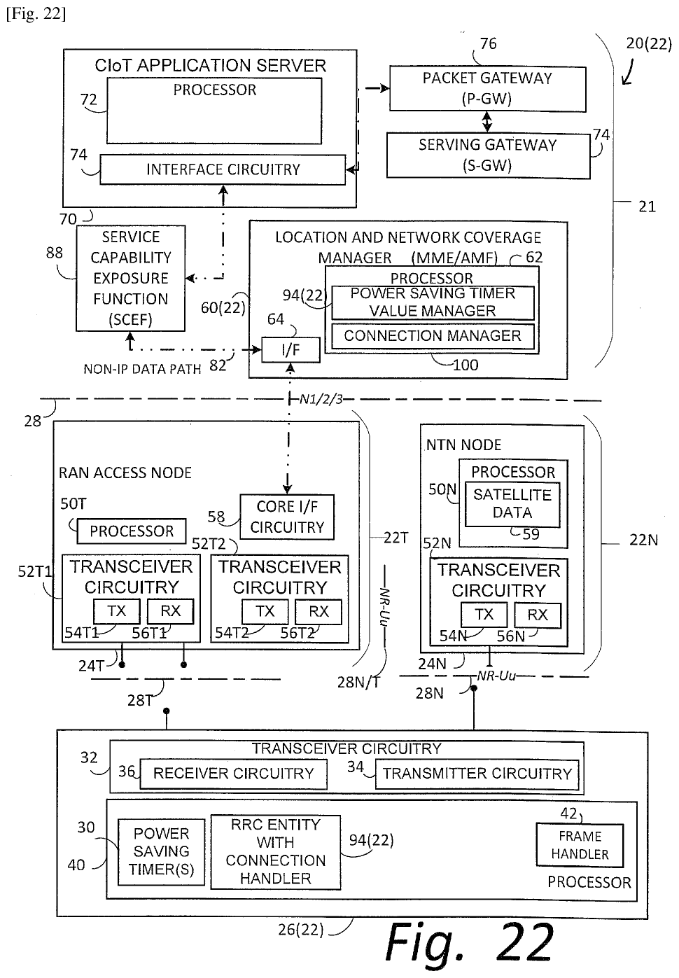

In one of its example aspects the technology disclosed herein includes example embodiments and modes in which the network may include new timers in a NAS DL message such as a connection release message. FIG. 22 shows an example embodiment and mode in which a core network node 60(22) comprises a connection manager 100 works in conjunction with power saving timer value manager 94(22) to includes a new or an adjusted timer value for one or more power saving timers in a connection release message. As previously explained, the core network node 60(22) may be a MME or an AMF node, or include such functionality. FIG. 22 shows that when the connection manager 100 core network node 60(22) determines that it is time to release a connection with the wireless terminal 26(22), the connection manager 100 obtains the new or adjusted timer value(s) from power saving timer value manager 94(22) and includes the adjusted timer value(s) in a connection release message which is depicted as arrow 102. The nodes, structures, and functionalities of FIG. 22 are the same as those of the generic example embodiment and mode of FIG. 9 unless otherwise indicated, particularly for elements having like reference numbers.

The new timers in a NAS DL message such as that of message 102 of FIG. 22 may comprise “DedicatedInfoNAS” encapsulated in the RRC Release message, as understood with reference to Table 8, and particularly to boldfaced portions thereof. The RRCConnectionRelease message may contain a release cause code, illustrated or named as “New NTN Timers”. The release cause code may indicate that new power saving timer values are available and they are to be used immediately following RRC release.

The DedicatedInfoNAS message may contain the Downlink ESM DATA Transport message with the new timer values, as understood with reference to Table 6.

### 4.0: Network Providing Multiple Power Saving Timer Values

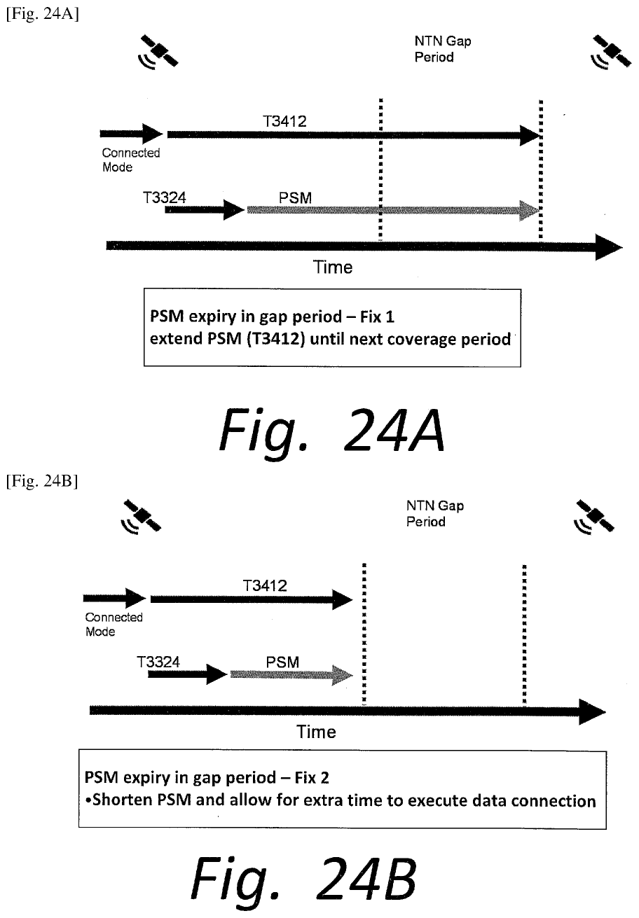

In another of its example aspects the technology disclosed herein comprises and/or encompasses example embodiments and modes in which a network, e.g., a core network, provides multiple candidate values for an adjusted timer value. In some implementations of this example embodiment and mode, the wireless terminal may select from among the multiple candidate values. For example, the network may provide multiple candidate power saving timer values if the network determines that the T3412 timer expires during the NTN Gap Period, as previously explained with reference to FIG. 16. For example, the network may calculate multiple T3412 timer values based on the current timer values or if UE makes a request for a new timer. An example of how multiple candidates may be derived for the timer values is understood with reference to FIG. 24A and FIG. 24B, which show differing resolution strategies. For example, the network may send both values as two candidate options, and the wireless terminal can decide which value to use.

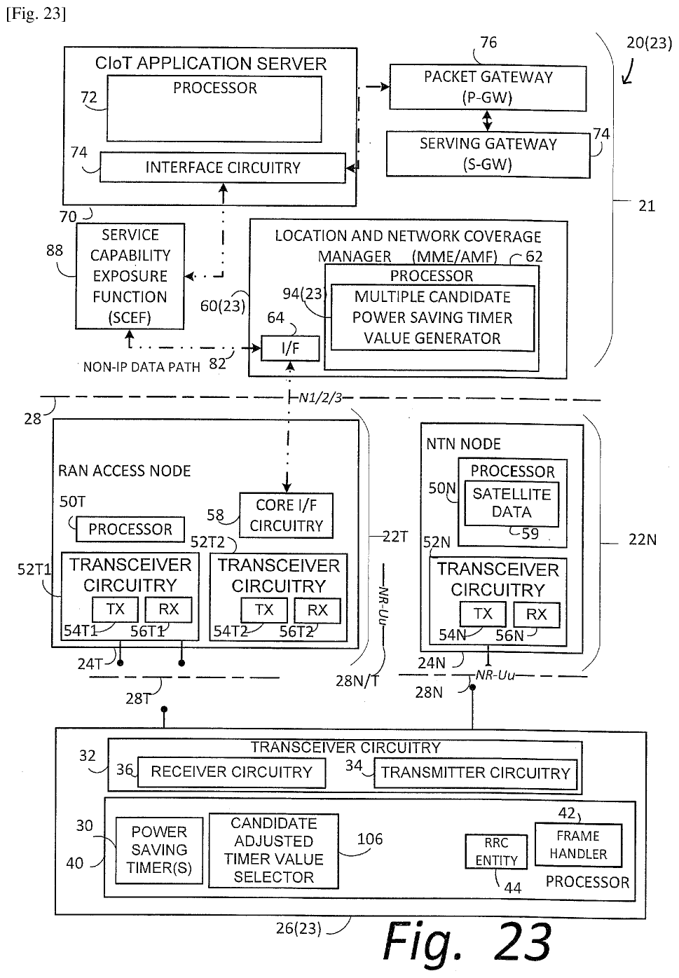

FIG. 23 shows an example communications network in which a core network, provides multiple candidate values for an adjusted timer value. FIG. 23 shows that core network node 60(23) includes multiple candidate power saving timer value generator 94(23) which includes multiple candidate adjusted timer value(s) in a message which is sent to wireless terminal 26(23) as depicted by arrow 104. The wireless terminal 26(23) comprises a candidate adjusted timer value selector 106 which choses among the multiple candidates received from the core network node 60(23). The nodes, structures, and functionalities of FIG. 23 are the same as those of the generic example embodiment and mode of FIG. 9 unless otherwise indicated, particularly for elements having like reference numbers.

The example embodiment and mode FIG. 23 thus includes wireless terminal 26(23), which communicates over a radio interface with a radio access network and comprises the power saving timer 30, terminal receiver circuitry 36, and terminal processor 40. The power saving timer 30 is configured to establish duration of one or more operational modes of the wireless terminal. The receiver circuitry is configured to receive, via the radio access network and from a core network node, plural candidate values for the power saving timer. The plural candidate timer values are preferably based on non-terrestrial network (NTN) coverage information for the wireless terminal. The processor circuitry is configured to select, from among the plural candidate values, an appropriate timer value for use as a selected timer value for the power saving timer. The selection may be performed, for example, by candidate adjusted timer value selector 106.

FIG. 24A and FIG. 24B illustrate two example cases or corrective or “fix” scenarios for which this example embodiment and mode may be particularly applicable, e.g., to remedy the situation of FIG. 16, for example. FIG. 24A shows that T3412 (PSM) may be extended to the start of next NTN Coverage Period. FIG. 24B shows that the T3412 (PSM) timer may be extended before the start of NTN Gap Period. In the case of FIG. 24B, there should be some period left after T3412 expiry to allow data transaction before no coverage starts.

In view of provision of multiple candidate adjusted timer values, The candidate adjusted timer value selector 106 of wireless terminal 26(23) may choose or select its preferred or most suitable candidate value option for the power saving mode, PSM, based on the values received from network.

Example structure and/or format of an example NAS DL message which may includes multiple candidates of power saving timer values is shown in Table 9.

TABLE 9
Downlink (Response) ESM DATA TRANSPORT message content

| | | | Pres- | For- | |
|---|---|---|---|---|---|
| IEI | Information Element | Type/Reference | ence | mat | Length |
| | Protocol discriminator | Protocol | M | V | ½ |
| | | discriminator | | | |
| | | 9.2 | | | |
| | EPS bearer identity | EPS bearer | M | V | ½ |
| | | identity | | | |
| | | 9.3.2 | | | |
| | Procedure transaction | Procedure | M | V | 1 |
| | identity | transaction | | | |
| | | identity | | | |
| | | 9.4 | | | |
| | ESM data transport | Message type | M | V | 1 |
| | message identity | 9.8 | | | |
| | User data container | User data | M | LV-E | 2-n |
| | | container | | | |
| | | 9.9.4.24 | | | |
| | Number of Timers (n) | | | | |
| | Network Updated T3412 | | O | TLV | 3 |
| | Network Updated T3324 | | O | TLV | 3 |
| | Network Updated eDRX | | O | TLV | 3 |
| | Network Updated T3412 | | O | TLV | 3 |
| | Network Updated T3324 | | O | TLV | 3 |
| | Network Updated eDRX | | O | TLV | 3 |
| | . . . | | | | |

### 5.0: Network Providing Newly Defined Power Savings Timer

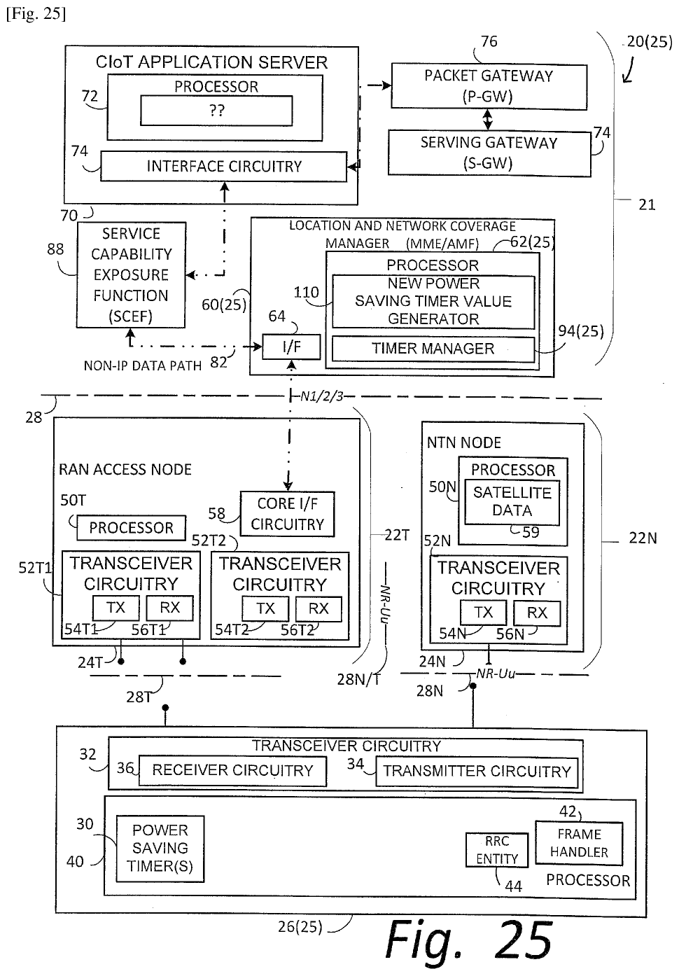

In one of its example aspects the technology disclosed herein comprises or encompasses a network, e.g., a core network, which provides a new power savings timer for use by the wireless terminal in conjunction with a non-terrestrial network (NTN). Whereas the T3412 timer and T3324 timer are examples of pre-existing or industry standard timers, the example embodiment and mode of FIG. 25 the network may provide an additional, novel, yet non-standardized timer of a type which the wireless terminal 26(25) has not been operating before provision of the new timer. FIG. 25 shows an example embodiment and mode in which a core network node 60(25) comprises power saving timer value manager 94(25) that includes novel or new timer generator 110. The location and network coverage manager 60(25) includes identification of a new power saving timer and a value therefor in a message which is sent to wireless terminal 26(25). The nodes, structures, and functionalities of FIG. 25 are the same as those of the generic example embodiment and mode of FIG. 9 unless otherwise indicated, particularly for elements having like reference numbers.

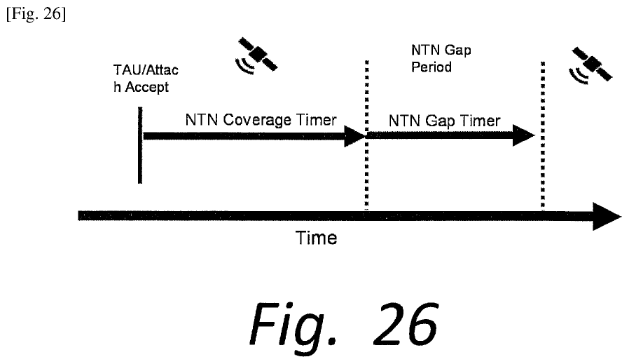

The network of FIG. 25 is aware of discontinuous coverage time(s) and therefore the new timers that the network of FIG. 25 generates are based on when the response is sent to the wireless terminal 26(25). Example new timers of the example embodiment and mode of FIG. 25, which may be generated by new timer generator 110, may include an NTN Coverage Timer and an NTN Gap Timer. The NTN Coverage Timer counts or determines time remaining until the NTN network coverage disappears. NTN Coverage Timer may be determined by the difference between timestamp of when response was sent to the wireless terminal 26(25) and the timestamp of the start of NTN Gap Period. The duration of NTN Coverage Timer may be several seconds shorter than the actual NTN coverage time to allow request for RRC Release by the network. The NTN Gap Timer counts or determines the duration of no NTN coverage, which is also known as the NTN Gap Period. The NTN Coverage Timer and the NTN Gap Timer are illustrated in FIG. 26.

The example embodiment and mode of FIG. 25 thus includes a node 60(25) of a core network which comprises processor circuitry 62(25) and interface circuitry 64. The processor circuitry is configured to generate a new mode-duration determination parameter for a wireless terminal served by the node. The interface circuitry is configured to transmit a message including the new mode-duration determination parameter to a radio access network which serves the wireless terminal. The wireless terminal 26(25) of the FIG. 25 example embodiment and mode comprises receiver circuitry and processor circuitry. The receiver circuitry is configured to receive the new mode-duration determination parameter via the radio access network and from a core network node. The processor circuitry is configured to use the new mode-duration determination parameter to determine duration of a mode of operation of the wireless terminal. In one example implementation the new mode-duration determination parameter is a parameter which express a time remaining until non-terrestrial network (NTN) coverage disappears for a wireless terminal served by the node. In another example implementation the new mode-duration determination parameter is a parameter which expresses duration of a non-terrestrial network (NTN) gap period for a wireless terminal served by the node. It should be understood that one or both of the new mode-duration determination parameters may be generated and transmitted to the wireless terminal, and when both are generated the parameters may be send individually or together in a same message.

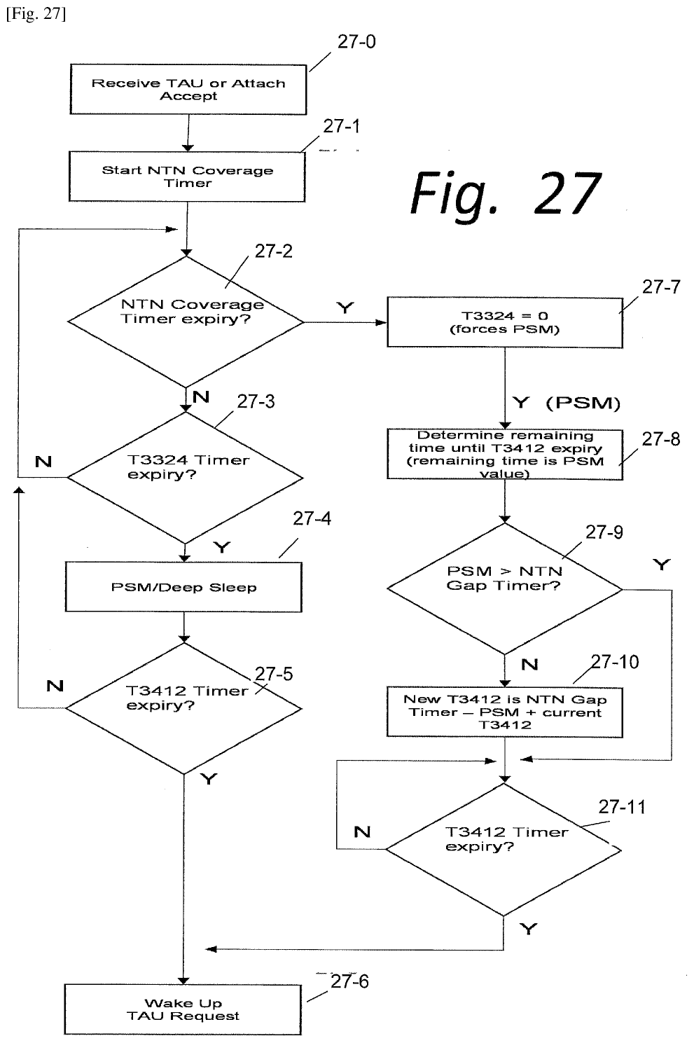

The new timers of the example embodiment and mode of FIG. 25 may be included in TAU or Attach Accept messages having example formats and contents shown, by way of example, in Table 10 and Table 11, respectively. The wireless terminal 26(25) may execute following procedures after receiving network response with NTN timers. NTN timers may be utilized by the wireless terminal 26(25) as follows and as shown by the representative example acts or steps of FIG. 27:

Act 27-0 comprises the wireless terminal 26(25) receiving a TAU/Attach Accept message, after which NTN Coverage Timer starts as depicted by act 27-1. Act 27-2 comprises the wireless terminal 26(5) continuously monitoring for expiry of the NTN Coverage timer. If the NTN Coverage Timer expires during connected or idle mode, the wireless terminal 26(25) immediately transitions to PSM/deep sleep mode and T3324 is set to 0 reflected by act 27-7.

If the PSM duration, remaining time until expiration of T3412, as calculated at act 27-8, is less than NTN Gap Timer, as determined at act 27-9, the timer T3412 may be adjusted to match the duration of NTN Gap Timer as shown by act 27-10. The wireless terminal continues PSM until expiration of T3412 as shown by act 27-11. If T3412 expires, the wireless terminal wakes up and performs a TAU request as depicted by act 27-5.

TABLE 10

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Attach accept message | Message type | M | V | 1 |
| | identity | 9.8 | | | |
| | EPS attach result | EPS attach result | M | V | ½ |
| | | 9.9.3.10 | | | |
| | Spare half octet | Spare half octet | M | V | ½ |
| | | 9.9.2.9 | | | |
| | T3412 value | GPRS timer | M | V | 1 |
| | | 9.9.3.16 | | | |
| | TAI list | Tracking area identity list | M | LV | 7-97 |
| | | 9.9.3.33 | | | |
| | ESM message container | ESM message container | M | LV-E | 5-n |
| | | 9.9.3.15 | | | |
| 50 | GUTI | EPS mobile identity | O | TLV | 13 |
| | | 9.9.3.12 | | | |
| 13 | Location area | Location area identification | O | TV | 6 |
| | identification | 9.9.2.2 | | | |
| 23 | MS identity | Mobile identity | O | TLV | 7-10 |
| | | 9.9.2.3 | | | |
| 53 | EMM cause | EMM cause | O | TV | 2 |
| | | 9.9.3.9 | | | |
| 17 | T3402 value | GPRS timer | O | TV | 2 |
| | | 9.9.3.16 | | | |
| 59 | T3423 value | GPRS timer | O | TV | 2 |
| | | 9.9.3.16 | | | |
| 4A | Equivalent PLMNs | PLMN list | O | TLV | 5-47 |
| | | 9.9.2.8 | | | |
| 34 | Emergency number list | Emergency number list | O | TLV | 5-50 |
| | | 9.9.3.37 | | | |
| 64 | EPS network feature | EPS network feature | O | TLV | 3-4 |
| | support | support | | | |
| | | 9.9.3.12A | | | |
| F- | Additional | Additional update result | O | TV | 1 |
| | update result | 9.9.3.0A | | | |
| 5E | T3412 extended value | GPRS timer 3 | O | TLV | 3 |
| | | 9.9.3.16B | | | |
| 6A | T3324 value | GPRS timer 2 | O | TLV | 3 |
| | | 9.9.3.16A | | | |
| 6E | Extended DRX parameters | Extended DRX parameters | O | TLV | 3 |
| | | 9.9.3.46 | | | |
| 65 | DCN-ID | DCN-ID | O | TLV | 4 |
| | | 9.9.3.48 | | | |
| E- | SMS services status | SMS services status | O | TV | 1 |
| | | 9.9.3.4B | | | |
| D- | Non-3GPP NW provided | Non-3GPP NW provided | O | TV | 1 |
| | policies | policies | | | |
| | | 9.9.3.49 | | | |
| 6B | T3448 value | GPRS timer 2 | O | TLV | 3 |
| | | 9.9.3.16A | | | |
| C- | Network policy | Network policy | O | TV | 1 |
| | | 9.9.3.52 | | | |
| 6C | T3447 value | GPRS timer 3 | O | TLV | 3 |
| | | 9.9.3.16B | | | |
| 7A | Extended emergency | Extended emergency | O | TLV-E | 7-65538 |
| | number list | number list | | | |
| | | 9.9.3.37A | | | |
| 7C | Ciphering key data | Ciphering key data | O | TLV-E | 35-2291 |
| | | 9.9.3.56 | | | |
| 66 | UE radio capability ID | UE radio capability ID | O | TLV | 3-n |
| | | 9.9.3.60 | | | |
| B- | UE radio capability ID | UE radio capability ID | O | TV | 1 |
| | deletion indication | deletion indication | | | |
| | | 9.9.3.61 | | | |
| 35 | Negotiated WUS assistance | WUS assistance | O | TLV | 3-n |
| | information | information | | | |
| | | 9.9.3.62 | | | |
| 36 | Negotiated DRX parameter | NB-S1 DRX parameter | | TLV | 3 |
| | in NB-S1 mode | 9.9.3.63 | | | |
| | NTN Coverage Timer | | O | TLV | 3 |
| | NTN Gap Timer | | O | TLV | 3 |

TABLE 11

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Tracking area update accept message identity | Message type | M | V | 1 |
| | | 9.8 | | | |
| | EPS update result | EPS update result | M | V | ½ |
| | | 9.9.3.13 | | | |
| | Spare half octet | Spare half octet | M | V | ½ |
| | | 9.9.2.9 | | | |
| 5A | T3412 value | GPRS timer | O | TV | 2 |
| | | 9.9.3.16 | | | |
| 50 | GUTI | EPS mobile identity | O | TLV | 13 |
| | | 9.9.3.12 | | | |
| 54 | TAI list | Tracking area identity list | O | TLV | 8-98 |
| | | 9.9.3.33 | | | |
| 57 | EPS bearer context status | EPS bearer context status | O | TLV | 4 |
| | | 9.9.2.1 | | | |
| 13 | Location area identification | Location area identification | O | TV | 6 |
| | | 9.9.2.2 | | | |
| 23 | MS identity | Mobile identity | O | TLV | 7-10 |
| | | 9.9.2.3 | | | |
| 53 | EMM cause | EMM cause | O | TV | 2 |
| | | 9.9.3.9 | | | |
| 17 | T3402 value | GPRS timer | O | TV | 2 |
| | | 9.9.3.16 | | | |
| 59 | T3423 value | GPRS timer | O | TV | 2 |
| | | 9.9.3.16 | | | |
| 4A | Equivalent PLMNs | PLMN list | O | TLV | 5-47 |
| | | 9.9.2.8 | | | |
| 34 | Emergency number list | Emergency number list | O | TLV | 5-50 |
| | | 9.9.3.37 | | | |
| 64 | EPS network feature support | EPS network feature support | O | TLV | 3-4 |
| | | 9.9.3.12A | | | |
| F- | Additional update result | Additional update result | O | TV | 1 |
| | | 9.9.3.0A | | | |
| 5E | T3412 extended value | GPRS timer 3 | O | TLV | 3 |
| | | 9.9.3.16B | | | |
| 6A | T3324 value | GPRS timer 2 | O | TLV | 3 |
| | | 9.9.3.16A | | | |
| 6E | Extended DRX parameters | Extended DRX parameters | O | TLV | 3 |
| | | 9.9.3.46 | | | |
| 68 | Header compression configuration status | Header compression | O | TLV | 4 |
| | | configuration status | | | |
| | | 9.9.4.27 | | | |
| 65 | DCN-ID | DCN-ID | O | TLV | 4 |
| | | 9.9.3.48 | | | |
| E- | SMS services status | SMS services status | O | TV | 1 |
| | | 9.9.3.4B | | | |
| D- | Non-3GPP NW policies | Non-3GPP NW provided | O | TV | 1 |
| | | policies | | | |
| | | 9.9.3.49 | | | |
| 6B | IT3448 value | GPRS timer 2 | O | TLV | 3 |
| | | 9.9.3.16A | | | |
| C- | Network policy | Network policy | O | TV | 1 |
| | | 9.9.3.52 | | | |
| 6C | T3447 value | GPRS timer 3 | O | TLV | 3 |
| | | 9.9.3.16B | | | |
| 7A | Extended emergency number list | Extended emergency number | O | TLV-E | 7-65538 |
| | | list | | | |
| | | 9.9.3.37A | | | |
| 7C | Ciphering key data | Ciphering key data | O | TLV-E | 35-2291 |
| | | 9.9.3.56 | | | |
| 66 | UE radio capability ID | UE radio capability ID | O | TLV | 3-n |
| | | 9.9.3.60 | | | |
| B- | UE radio capability ID deletion indication | UE radio capability ID deletion | O | TV | 1 |
| | | indication | | | |
| | | 9.9.3.61 | | | |
| 35 | Negotiated WUS assistance information | WUS assistance information | O | TLV | 3-n |
| | | 9.9.3.62 | | | |
| 36 | Negotiated DRX parameter in NB-S1 mode | NB-S1 DRX parameter | O | TLV | 3 |
| | | 9.9.3.63 | | | |
| | NTN Coverage Timer | | O | TLV | 3 |
| | NTN Gap Timer | | O | TLV | 3 |

6.0: Network Releasing Connection if NTN Gap Period is about to Start

In one of its example aspects the technology disclosed herein comprises or encompasses example embodiments and modes in which a network may release a connection if the network determines that a non-terrestrial network (NTN) Gap Period is about to start. For example, the core network may release the connection if a core network node such as MME/AMF determines that NTN Gap Period is about to start. The determination that a non-terrestrial network (NTN) Gap Period is about to start may be analogous and thus determined similarly to terrestrial cellular systems in which a data activity timer or the like is used. The timer starts when no data activity is detected. If no activity is detected for 10 s, 20 s, etc, the eNB/gNB will release the connection. The configuration is dependent upon the network, e.g., Verizon may set the timer to 20 seconds but AT&T may set it to 40 seconds, T-Mobile to 60 sec, etc. Therefore, a way to determine when a NTN Gap period is “about to start” may comprise use of a similar network configured timer. For example, a network may configure a timer such as “pre-NTN gap timer” to 30 seconds. In such case, the connection is released 30 seconds before start of gap period time.

The network may execute a RRC Release during connected or idle mode. The RRCConnectionRelease message may contain an IE indicating that the NTN Gap Period will start. The wireless terminal may immediately transition to PSM if a release cause included in the RRCConnectionRelease is set to NTN-DeepSleep or equivalent, e.g., to a new IE.

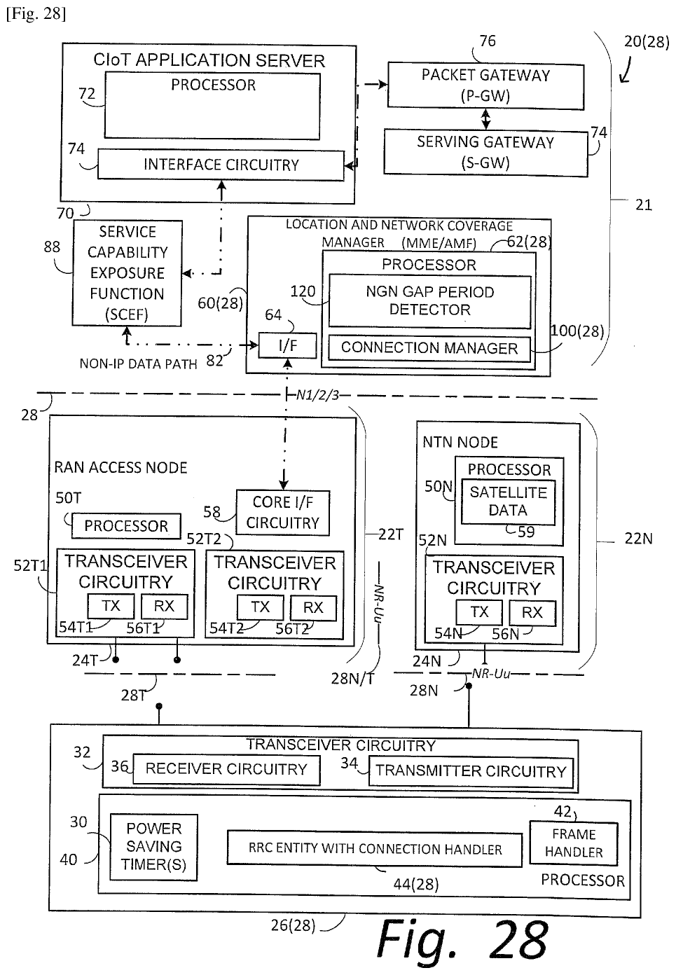

FIG. 28 shows an example embodiment and mode in which a core network node 60(28) releases a connection if the network determines that a non-terrestrial network (NTN) Gap Period is about to start. The core network node 60(28) comprises connection manager 100(28) and NTN Gap Period detector 120. If the NTN Gap Period detector 120 determines that a Gap Period is about to start, the connection manager 100(28) of the core network node 60(28) generates a connection release message. The NTN Gap Period detector 120 knows when the NTN Gap Period starts because information may be received by the network from a server or another entity. For example, now briefly described, a central server may acquire ephemeris data from various satellites and possibly location data from CIoT devices. The ephemeris and location data are used in orbit propagator or Keplerian motion algorithms which can output start and stop of satellite pass times. There may also exist other algorithms to determine start and stop times of coverage/no coverage. Thus, knowing the start time of the NTN Gap period, the node 60(28) may determine an “about to start” time as pre-determined time before the actual start of the NTN Gap Period. The pre-determined “about to start” time may be, for example, 30 seconds. Thus, if the network determines that NTN gap period will occur in 30 seconds or less (the “about to start” time), then a connection release occurs.

The connection release message may include a release “cause” information element or flag or indication. As indicated above, the wireless terminal 26(28) may immediately transition to power saving mode (PSM) if the release cause included in the RRCConnectionRelease is set to NTN-DeepSleep or equivalent. The release cause in the RRCConnectionRelease is recognized and acted upon by the RRC entity with connection handler 44(28) of wireless terminal 26(28). The nodes, structures, and functionalities of FIG. 28 are the same as those of the generic example embodiment and mode of FIG. 9 unless otherwise indicated, particularly for elements having like reference numbers.

The example embodiment and mode of FIG. 28 includes node 60(28) of a core network of a telecommunications system. The node comprises processor circuitry and interface circuitry. The processor circuitry is configured, when a determination has been made that a non-terrestrial network (NTN) gap period is about to start for a wireless terminal served by the core network node, to (1) generate a connection release message for the wireless terminal; and (2) provide a timer value for a power saving timer of a wireless terminal served by the core network, the timer value being based on non-terrestrial network (NTN) coverage information for the wireless terminal. The interface circuitry is configured to transmit the connection release message and the timer value to a radio access network which serves the wireless terminal.

The example embodiment and mode of FIG. 28 also includes wireless terminal 26(28) which communicates over a radio interface with a radio access network. In a basic example embodiment and mode the wireless terminal comprises receiver circuitry and processor circuitry. The receiver circuitry is configured to receive, via the radio access network from a core network node that serves the wireless terminal, a connection release message, the connection release message having been sent to the wireless terminal from the core network node when the core network node has made a determination that a non-terrestrial network (NTN) gap period is about to start for the wireless terminal. The processor circuitry is configured, upon receipt of the connection release message, to transition the wireless terminal into a power saving mode.

The new information element, e.g., NTN-DeepSleep, is described by way of example with reference to Table 12 and particularly to boldfaced portions thereof. The presence of this new IE, e.g., NTN-DeepSleep may inform the wireless terminal of the following information:
a) The timer T3324 is set to 0 after RRC Release, so that the wireless terminal immediately changes state to PSM/deep sleep.
b) A DedicatedInfoNAS message that comprises downlink ESM DATA Transport with new T3412 value (see Table 13).

TABLE 13
Downlink (Response) with RRC Connection Release
ESM DATA TRANSPORT message content

| | | | Pres- | For- | |
|---|---|---|---|---|---|
| IEI | Information Element | Type/Reference | ence | mat | Length |
| | Protocol | Protocol | M | V | ½ |
| | discriminator | discriminator | | | |
| | | 9.2 | | | |
| | EPS bearer identity | EPS bearer identity | M | V | ½ |
| | | 9.3.2 | | | |
| | Procedure | Procedure | M | V | 1 |
| | transaction | transaction | | | |
| | identity | identity | | | |
| | | 9.4 | | | |
| | ESM data transport | Message type | M | V | 1 |
| | message identity | 9.8 | | | |
| | User data container | User data container | M | LV-E | 2-n |
| | | 9.9.4.24 | | | |
| | T3412 | Deep Sleep Period | | | |
| | | (NTN Gap Period) | | | |

### 7.0: Use of Release Assistance Indication for Power Saving Timer Adjustments

In one of its aspects the technology disclosed herein comprises or encompasses the use of a Release Assistance Indication, RAI, for power savings adjustments. The RAI may be used for triggering early RRC Release as wireless terminal may have no additional data to send and desires to change state from connected to idle mode, which triggers the start of timer T3412 and timer T3324. An Uplink RRC message encapsulating a NAS PDU may contain the RAI and an additional flag indicating a request for updated power saving timer(s). The additional flag indicating a request for updated power saving timer(s) is understood with reference to Table 14. Instead of a flag, the NAS PDU may contain power saving timers set to 0. The network response to an RAI timer request may be included in RRC Connection Release message. Network response with timer values may also be received by the UE as a NAS PDU downlink data.

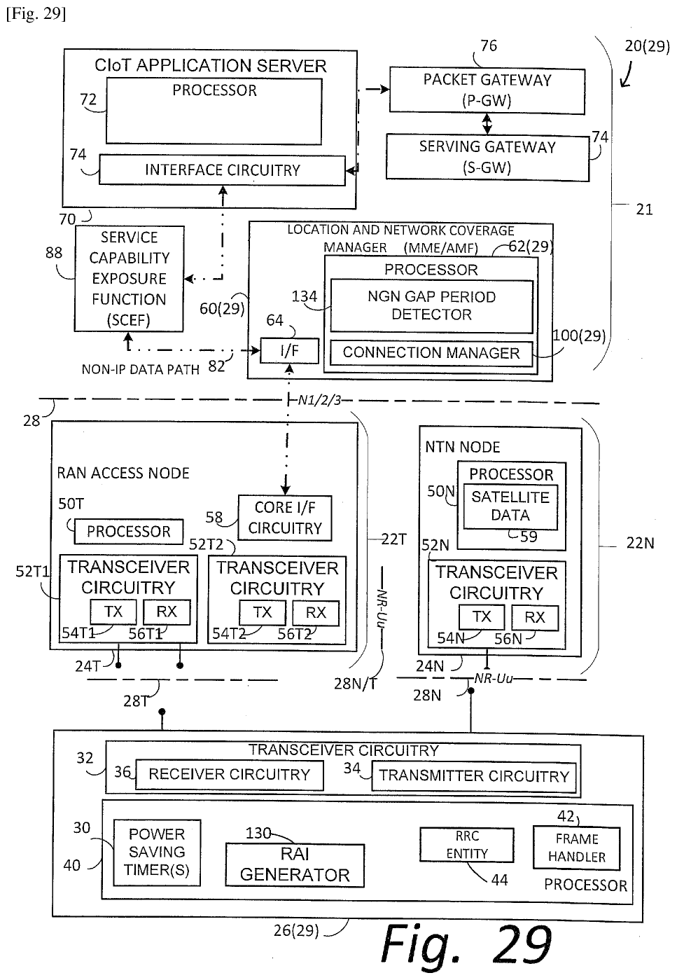

FIG. 29 shows an example embodiment and mode in which a message including a Release Assistance Indication may be used to change the state of wireless terminal 26(29) to an idle mode and to request updated power saving timer(s). The wireless terminal 26(29) includes Release Assistance Indication generator 130, which may be realized or comprised by terminal processor 40. The Release Assistance Indication generator 130 may prompt generation of an uplink message which includes the Release Assistance Indication and also may include a request for new power saving timer values. Information from the uplink message is received by the core network node 60(29), which comprises connection manager 100(29) and power saving timer value manager 134. The connection manager 100(29) may, in response to receipt of the Release Assistance Indication, generate or prompt a connection release message and may include new or updated power saving timer values in the connection release message or otherwise cause the sending of the new or updated power saving timer values to the wireless terminal 26(29). The nodes, structures, and functionalities of FIG. 29 are the same as those of the generic example embodiment and mode of FIG. 9 unless otherwise indicated, particularly for elements having like reference numbers.

The example embodiment and mode of FIG. 29 includes node 60(29) of a core network of a telecommunications system. The core network node comprises interface circuitry 64 and processor circuitry 62(29). The interface circuitry is configured to receive, via a radio access network from a wireless terminal: (1) an early release indication which has been generated when a determination has been made that the wireless terminal has no additional data to transmit across the radio interface and that the wireless terminal should change state from a connected mode to an idle mode; and (2) a request for an updated value for a power saving timer of the wireless terminal. The processor circuitry is configured to configure the updated value for the power saving timer of the wireless terminal. The interface circuitry is further configured to transmit, via the radio access network, a connection release message and the updated value for the power saving timer.

The example embodiment and mode of FIG. 29 also includes wireless terminal 26(29) which communicates over a radio interface with a radio access network. The wireless terminal comprises processor circuitry 40, transmitter circuitry 34, and receiver circuitry 36. The processor circuitry is configured to make a determination that the wireless terminal has no additional data to transmit across the radio interface and that the wireless terminal should change state from a connected mode to an idle mode. Further, in accordance with the determination, the processor circuitry is configured to generate an early release indication and to generate a request for an updated value for a power saving timer of the wireless terminal. The transmitter circuitry is configured to transmit the early release indication and the request for the updated value for the power saving timer to a core network node via the radio access network. The receiver circuitry is configured to receive, via the radio access network, a connection release message and the updated value for the power saving timer.

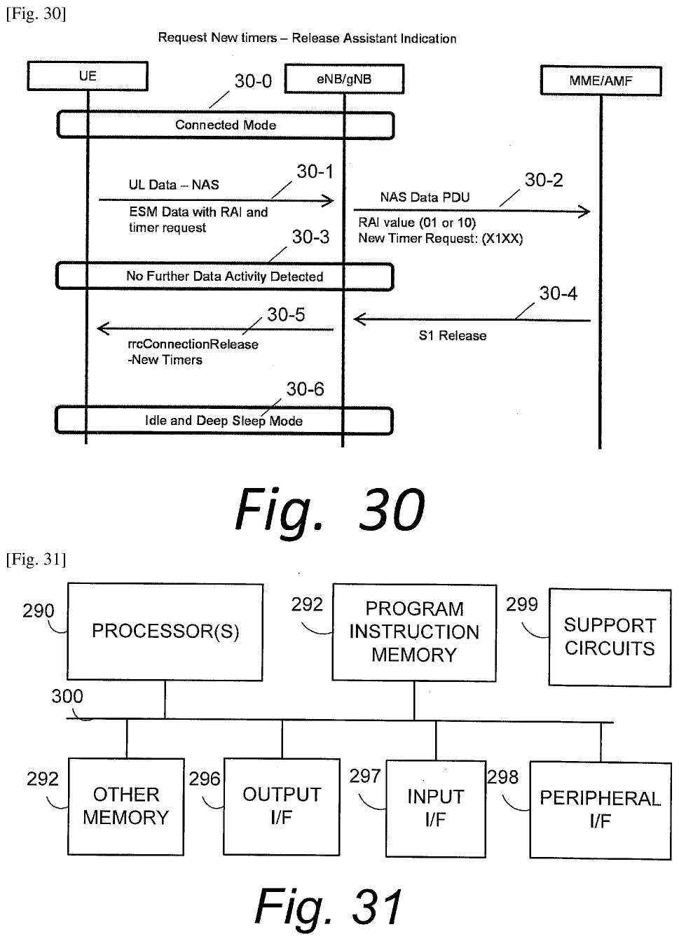

FIG. 30 illustrates example, representative events which may be involved in use of the Release Assistance Indication for power savings adjustment. Event 30-0 shows the wireless terminal as being in connected mode. Event 30-1 reflects that fact that the wireless terminal is sending data over the non-access stratum to the radio access node, e.g., to access node 24, and includes in such data a Release Assistance Indication. Event 30-2 comprises the access node 24 sending a NAS data PDU including the Release Assistance Indication to the core network node, e.g., to the MME or AMF. Included or inherent in the NAS Data PDU is a request for new power saving timer values. Event 30-3 reflects no further data activity detected involving the wireless terminal, which is consistent with the Release Assistance Indication previously sent. As event 30-4 the core network node sends a connection release message, shown as S1 release, to access node 24. As event 30-5 the access node 24 in turn sends an RRCConnectionRelease message to the wireless terminal. The RRCConnectionRelease message of Event 30-5 may include the new power saving timer values. Event 30-6 shows that the wireless terminal, upon receipt of the connection release message of Event 30-5, enters the power saving mode (PSM).

TABLE 14

| | | | | | | | |
|---|---|---|---|---|---|---|---|
| 8 | 7 | 6 | 5 | 4 | 3 | 2 | 1 |

| Release assistance | 0 | 0 | DDX | octet 1 |
|---|---|---|---|---|
| indication | Spare | NTN | | |
| IEI | | Timer | | |

Request

3GPP 24.301-h30 describes the Release Assistance Indication IE modification as shown in Table 15:

TABLE 15
“9.9.4.25 Release assistance indication
The purpose of the Release assistance indication IE is to inform the
network whether
- no further uplink and no further downlink data transmission
is expected; or
- only a single downlink data transmission (e.g. acknowledgement
or response to uplink data) and no further uplink data transmission
subsequent to the uplink data transmission is expected.
- a request for new power saving timers as the UE may transition to
discontinuous coverage
The Release assistance indication information element is coded as shown
in figure 9.9.4.25.1 and table 9.9.4.25.1.
The Release assistance indication is a type 1 information element.”

The RAI message may also contain updated timer values as calculated by the wireless terminal, as understood with reference to Table 16. This message may inform the network that the included timers calculated by the wireless terminal are to be used and starts at RRC Release.

TABLE 16
Uplink RAI ESM DATA TRANSPORT message content

| | | | Pres- | For- | |
|---|---|---|---|---|---|
| IEI | Information Element | Type/Reference | ence | mat | Length |
| | Protocol | Protocol | M | V | ½ |
| | discriminator | discriminator | | | |
| | | 9.2 | | | |
| | EPS bearer identity | EPS bearer identity | M | V | ½ |
| | | 9.3.2 | | | |
| | Procedure | Procedure | M | V | 1 |
| | transaction | transaction | | | |
| | identity | identity | | | |
| | | 9.4 | | | |
| | ESM data transport | Message type | M | V | 1 |
| | message identity | 9.8 | | | |
| | User data container | User data container | M | LV-E | 2-n |
| | | 9.9.4.24 | | | |
| | Release assistance | Release assistance | O | TV | 1 |
| | | indication | | | |
| | indication | 9.9.4.25 | | | |
| | UE Updated T3412 | | O | TLV | 3 |
| | UE Updated T3324 | | O | TLV | 3 |
| | UE Updated eDRX | | O | TLV | 3 |

The RAI message may also contain a flag to indicate that wireless terminal will immediately transition to PSM. An example of such flag is understood from Table 17. In this case, the wireless terminal may set the value of timer T3324 to 0 and timer T3412 so that at the very least it matches the NTN Gap Period. Once network receives this indication, the connection is released without any wait period and rrcConnectionRelease message is sent to the wireless terminal.

TABLE 17
Release assistance indication information element
Release assistance indication value
Downlink data expected (DDX)

| Bits | | |
|---|---|---|
| 2 | 1 | |
| 0 | 0 | No information regarding DDX is conveyed by the information |
| | | element. If received it shall be interpreted as ‘neither value “01” |
| | | nor “10” applies’ |
| 0 | 1 | No further uplink and no further downlink data transmission |
| | | subsequent to the uplink data transmission is expected |
| 1 | 0 | Only a single downlink data transmission and no further uplink |
| | | data transmission subsequent to the uplink data transmission is |
| | | expected |
| 1 | 1 | Reserved |

Bits 3 and 4

| 3 | 4 | |
|---|---|---|
| 0 | 1 | |
| 1 | 0 | New NTN immediate transition to PSM |

Non-limiting example advantages and features of the connected mode example embodiments and modes described above include the following:
FIG. 31 shows other possible components and functionalities of wireless terminals 26 and various nodes of the various example embodiments and modes described herein. In addition to processor circuitry the wireless terminals and various nodes described herein may also comprises terminal memory, e.g., memory circuitry, which may store an operating system and various application programs. The memory may be any suitable type of memory, e.g., random access memory (RAM), read only memory (ROM), cache memory, processor register memory, or any combination of one or more memory types. The applications comprising instructions executable by the processor circuitry and are stored in non-transient portions of terminal memory. At least some aspects of the memory for the wireless terminals may also be considered as part of the power saving timers
In at least some example embodiments and modes, e.g., more sophisticated embodiment and modes, wireless terminal 26 may further comprise terminal user interface(s). The user interfaces may comprise one or more suitable input/output devices which are operable by a user. Some or all user interfaces may be realized by a touch sensitive screen. The user interface(s) may also comprise a keyboard, audio input and output, and other user I/O devices. The user interfaces may be provided on a cover or case of wireless terminal.

Certain units and functionalities of the wireless terminals 26, of access nodes 24, or of any of the core network nodes, such as a core network node 60, Service Capability Exposure Function (SCEF) 90, and CIoT application server 60, may be implemented by terminal electronic machinery. FIG. 31 shows an example of such electronic machinery as comprising one or more processors 290, program instruction memory 292; other memory 294 (e.g., RAM, cache, etc.); input/output interfaces 296 and 297, peripheral interfaces 298; support circuits 299; and busses 300 for communication between the aforementioned units. The processor(s) 290 may comprise the processor circuitries described herein, for example, the terminal processor 40 of the wireless terminals 26, the node processor circuitry 50 of access nodes 24, core node processor 62 of the core node 60, and application server processor 72 of CIoT application server 70.

The memory 294, or non-transitory computer-readable medium, may be one or more of readily available memory such as random access memory (RAM), read only memory (ROM), floppy disk, hard disk, flash memory or any other form of digital storage, local or remote, and is preferably of non-volatile nature, and as such may comprise memory 294. The support circuits 299 are coupled to the processors 290 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the user equipment 26 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

One or more features of the example embodiments and modes described herein may be used in conjunction with one or more other features, in any combination.

The technology disclosed herein thus comprises and compasses the following nonexhaustive example embodiments and modes:

It will be appreciated that the technology disclosed herein is directed to solving radio communications-centric issues and is necessarily rooted in computer technology and overcomes problems specifically arising in radio communications. Moreover, the technology disclosed herein improves basic function of a wireless terminal, e.g., a user equipment, a network node, and a base station, so that, for example, operation of these entities may occur more effectively by prudent use of radio resources, especially for wake up signaling monitoring and detection. For example, the technology disclosed herein enables the user equipment 26 to judiciously enabling and disable wake up signaling detection, particularly in view of quality of service and other concerns/issues.

Although the description above contains many specificities, these should not be construed as limiting the scope of the technology disclosed herein but as merely providing illustrations of some of the presently preferred embodiments of the technology disclosed herein. Thus, the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A wireless terminal which communicates over a radio interface with a radio access network, the wireless terminal comprising:
a power saving timer configured to establish duration of one or more operational modes of the wireless terminal, each operational mode being associated with a respective power utilization level by the wireless terminal;
receiver circuitry configured to receive, via the radio access network and from a core network node, a timer value for the power saving timer, the timer value being based on non-terrestrial network (NTN) coverage information for the wireless terminal.

2. The wireless terminal of claim 1, wherein use of the timer value causes the wireless terminal to be in a power saving mode (PSM) throughout a non-terrestrial network (NTN) gap period.

3. The core network node of claim 1, wherein the wireless terminal further comprises transmitter circuitry which generates an uplink message from the wireless terminal, and wherein the timer value is set by the core access node in response to receiving the uplink message from the wireless terminal.

4. The wireless terminal of claim 3, wherein the uplink message is configured to include a flag which indicates to the core network node that the core network node is to adjust the power saving timer value.

5. The wireless terminal of claim 3, wherein the wireless terminal further comprises terminal processor circuitry configured to determine modified timer information in conjunction with a server in communication with the wireless terminal and to include the modified timer information as determined by the wireless terminal in conjunction with the server in communication in the uplink message, and wherein the core network node sets the power savings timer value based on the modified timer information.

6. The wireless terminal of claim 5, wherein in the uplink message one or both of a T3324 timer and an eDRX timer is shortened to ensure that neither the T3324 timer or the eDRX timer expire during the non-terrestrial network (NTN) gap period.

7. The wireless terminal of claim 5, wherein the uplink message includes a value for the T3412 timer so that the T3412 timer is extended until a start time of a next the non-terrestrial network (NTN) coverage period.

8. The wireless terminal of claim 5, wherein the uplink message includes a value for the T3324 timer so that the T3324 timer is extended until start of a non-terrestrial network (NTN) gap period and includes a value for the T3412 timer so that the T3412 timer is extended until a start time of a next the non-terrestrial network (NTN) coverage period.

9. A core network node of a core network of a telecommunications system, the core network node comprising:
processor circuitry configured to adjust a timer value for a power saving timer of a wireless terminal served by the core network, the timer value being based on non-terrestrial network (NTN) coverage information for the wireless terminal; and
interface circuitry configured to transmit a message including the timer value to a radio access network which serves the wireless terminal.

10. The core network node of claim 9, wherein the node processor circuitry sets the timer value so that the wireless terminal will be in a power saving mode (PSM) throughout a non-terrestrial network (NTN) gap period.

11. The core network node of claim 9, wherein the uplink message is configured to include a flag which indicates to the node processor circuitry of the core network node that the node processor circuitry of the core network node is to adjust the timer value.

12. The core network node of claim 9, wherein the uplink message is configured to include modified timer information received from the wireless terminal, and wherein the node processor circuitry of the core network node sets the timer value based on the modified timer information.

13. The core network node of claim 12, wherein the modified timer information is based on a determination by the wireless terminal that expiry of the time based on a current value for the timer occurs during a non-terrestrial network (NTN) gap period.

14. The core network node of claim 12, wherein in the uplink message a timer value for one or both of a T3324 timer and an eDRX timer is shortened to ensure that the T3324 timer and/or the eDRX timer do not expire during the non-terrestrial network (NTN) gap period.

15. The core network node of claim 12, wherein in the uplink message the timer value for the T3412 timer is adjusted so that the T3412 timer is extended until a start time of a next the non-terrestrial network (NTN) coverage period.
